(19) United States
(12) Patent Application Publication
(10) Pub. No.: US 2026/0119785 A1
(43) Pub. Date: Apr. 30, 2026

(54) ARTIFICIAL INTELLIGENCE BASED STRATEGIC INNOVATION SYSTEM

(71) Applicant: Sluice AI, Inc., Austin, TX (US)

(72) Inventors: Rush BARTLETT, Austin, TX (US); Frank WANG, Zhubei City (TW)

(21) Appl. No.: 19/414,993

(22) Filed: Dec. 10, 2025

Related U.S. Application Data
(63) Continuation of application No. PCT/US24/54418, filed on Nov. 4, 2024.
(60) Provisional application No. 63/595,754, filed on Nov. 3, 2023.
(60) Provisional application No. 63/616,529, filed on Dec. 30, 2023.
(60) Provisional application No. 63/562,244, filed on Mar. 6, 2024.
(60) Provisional application No. 63/686,615, filed on Aug. 23, 2024.

(51) Int. Cl. G06F 40/166; G06F 3/04842; G06F 40/40; H04L 51/02

(52) U.S. Cl. CPC G06F 40/166; G06F 40/40; G06F 3/04842; H04L 51/02

(57) ABSTRACT

Certain embodiments provide a computer that includes a memory and a processor coupled to the memory and a network. The memory stores phase modules for a strategic innovation process. Each phase module presents a user interface (UI) that includes a topic region and a chatbot region associated with a chatbot application coupled to a large language model (LLM). The topic region presents information created by a user and information created by the LLM. The chatbot region receives natural language text from the user's computer over a network, and presents information generated by the LLM. For each phase module, the processor sends the UI to the user's computer, receives natural language text, generates information for the topic region based at least in part on the natural language text, and sends the information for the topic region over the network to the user's computer.

### CROSS-REFERENCE TO RELATED APPLICATIONS

This application is a continuation of PCT Application No. PCT/US24/54418 (filed on Nov. 4, 2024) which claims the benefit of U.S. Provisional Application Ser. Nos. 63/595,754 (filed on Nov. 3, 2023), 63/616,529 (filed on Dec. 30, 2023), 63/562,244 (filed on Mar. 6, 2024), and 63/686,615 (filed on Aug. 23, 2024), the contents of which are incorporated by reference herein in their entireties.

### BACKGROUND

The present disclosure relates to computer systems, and, more particularly, to an artificial intelligence (AI) based strategic innovation system.

Creating new products and services are challenging tasks that involve significant research, idea development, and testing. A variety of methodologies, such as Agile Development, Biodesign, Lean Startup, Design Thinking, the Theory of Inventive Problem Solving (also known as TRIZ), and others, attempt to apply different innovation techniques in a standardized way so that any innovation team may be consistently successful. These innovation techniques may also use software tools, such as Excel, template-based applications, etc., to ensure that each step in the strategic innovation process has been completed before moving to the next step. Unfortunately, these innovation techniques contains flaws and pitfalls which often yield inconsistent results.

Machine Learning (ML), such as Generative AI, Large Language Models (LLMs), etc., may be used for summarization and output generation from a data set of input queries. Generally, Generative AI refers to any artificial intelligence that generates original content. Generative AI is built on one or more underlying AI models, such as LLMs, which are the text-generating portion of the Generative AI. While Generative AI may allow innovators to perform research more efficiently, these efforts are often plagued with “hallucinatory outputs” that produce a lack of confidence in the results. This lack of confidence limits the utility of Generative AI models for teams on the forefront of innovation.

### DESCRIPTION OF THE DRAWINGS

FIG. 1 depicts a diagram of a strategic innovation process, in accordance with embodiments of the present disclosure.

FIG. 2 depicts one view of a user interface, in accordance with embodiments of the present invention.

FIG. 3 depicts another view of the user interface, in accordance with embodiments of the present invention.

FIG. 4A depicts another view of the user interface, in accordance with embodiments of the present invention.

FIG. 4B depicts another view of the user interface depicted in FIG. 4A, in accordance with embodiments of the present invention.

FIG. 5 depicts a concept filtering diagram, in accordance with embodiments of the present invention.

FIG. 6 depicts a 600 for identifying or creating need statements from literature or interview guide questions, in accordance with embodiments of the present invention.

FIG. 7 depicts another view of the user interface, in accordance with embodiments of the present invention.

FIG. 8A depicts another view of the user interface, in accordance with embodiments of the present invention.

FIG. 8B depicts another view of the user interface depicted in FIG. 8A, in accordance with embodiments of the present invention.

FIG. 9 depicts another view of the user interface, in accordance with embodiments of the present invention.

FIG. 10 depicts another view of the user interface, in accordance with embodiments of the present invention.

FIG. 11 depicts a process for developing a solution to solve a need statement, in accordance with embodiments of the present invention.

FIG. 12 depicts a process for developing a scoring matrix for a need statement, in accordance with embodiments of the present invention.

FIG. 13 depicts a process for updating the need scoring, in accordance with embodiments of the present invention.

FIG. 14 depicts another view of the user interface, in accordance with embodiments of the present invention.

FIG. 15 depicts a process for determining a topic area, in accordance with embodiments of the present invention.

FIG. 16 depicts a process for determining need statements, in accordance with embodiments of the present invention.

FIG. 17 depicts a process for refining a need statement, in accordance with embodiments of the present invention.

FIG. 18 depicts another view of the user interface, in accordance with embodiments of the present invention.

### DETAILED DESCRIPTION

Embodiments of the present disclosure advantageously provide a system that combines a strategic innovation process and Generative AI capabilities with a longitudinal workflow that guides teams through the steps of the strategic innovation process to produce a desired result. A unified set of workflow improvements, tools, and technological advances are provided that enable Generative AI and LLMs to more efficiently contribute to the strategic innovation process. Modifying the inputs and outputs of LLMs based on different steps, as well as incorporating discrete databases of information for different steps, provides a more curated experience for the user and improves the output of the strategic innovation process.

Embodiments of the present disclosure also provide system and decision support tools that guide innovation across several dimensions or phases, such as an alignment phase, a research and observations phase, a solution agnostic phase, a solution generation phase, and a solution implementation phase. The phases may be industry specific, and may include such topics as insurance reimbursement, environmental regulation, Food and Drug Administration (FDA) regulation, patents, go-to market strategies, etc. The strategic innovation process may also include other phases or modules as well.

In certain embodiments, the phases may be used in a particular sequence, such as the alignment phase, the research and observations phase, the solution agnostic phase, the solution generation phase, and the solution implementation phase. In other embodiments, the phases may be used singly or in combination with one or more of the other phases. For example, a team may use the alignment phase alone. In another example, a team may use the alignment phase followed by the solution agnostic phase. And so on. Each phase may include multiple steps, and each step may include ML support, such as Generative AI, LLMs, etc. For example, the ML support may include GPT-based language model (such as ChatGPT, etc.), generative adversarial networks (GANs), variational autoencoders (VAEs), autoregressive models, recurrent neural networks (RNNs), transformer-based models (such as Bard, Llama2, etc.), diffusion models, flow-based models, neural radiance fields (NeRFs), etc. In some embodiments, the LLMs described below may be replaced by predictive AI models for the selection of discrete data and input text from a reference library of information.

In certain embodiments, the solution generation phase may include several steps, such as an external research of existing solutions step, an internal idea generation step, a filtering and prioritization step for the ideas that were generated, a solution generation step, etc. The filtering and prioritization step may be configured to select and prioritize the top list of ideas or concepts.

In other embodiments, once the solution has been generated, a predictive model and a search query may be used to search for inventions that are related to the solution from one or more data sets. For example, a Generative AI model may be used to generate the query string or embeddings to be used in the search. A comparison of the search results to the solution may identify which aspects of the solution may be novel and patentable.

Generally, the above embodiments and examples are not intended to be limiting. For example, each phase may include multiple steps, and there may be additional steps between the phases. Each tool provided within a step may be used separately, or, alternatively, the tool may be used in combination with another tool within the step, a different step within the phase, in combination with tools within other phases, etc.

Generally, the system is configured to implement the strategic innovation process by executing system software. In certain embodiments, the system software may include a main application that executes a sequence of modules, and each phase of the strategic innovation process may be implemented by one or more modules. The main application and the modules may also provide various components of a user interface. The system software may be hosted by a local computer, a remote network server, or a combination of the local computer and the remote network server. For example, the remote network server may execute the system software, and provide a number of HTML pages that are displayed in a browser window on the local computer.

Each module may also access a Generative AI tool, an LLM, etc., that may be hosted by the local computer, the remote network server, an AI network server, etc. The term “system,” as used below, refers to the combination of the system software, the local computer, the remote network server (when hosting or co-hosting the system software), and the AI network server (when hosting the Generative AI tool, the LLM, etc.). The modules may also access other network resources, such as network databases, web sites, etc., as described below.

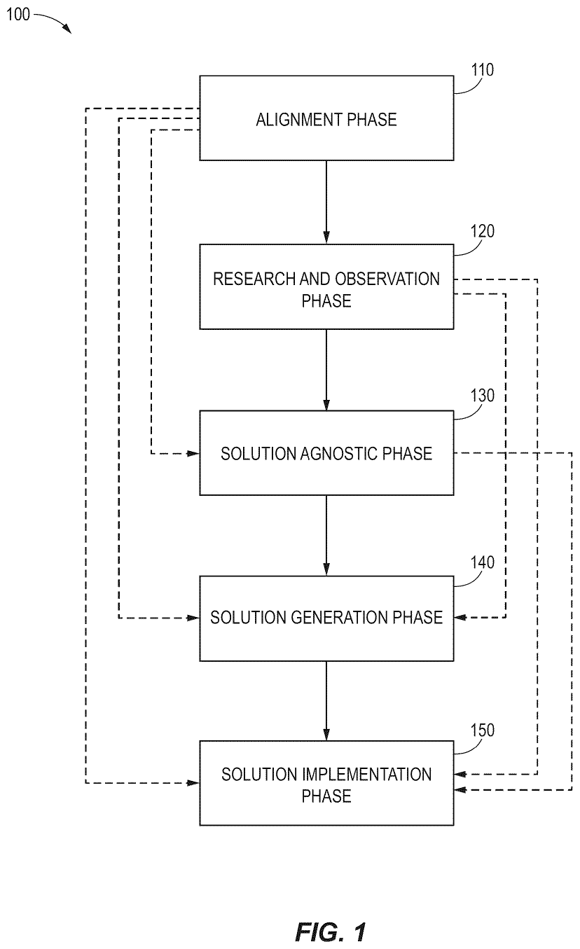

FIG. 1 depicts a diagram of a strategic innovation process 100, in accordance with embodiments of the present disclosure.

In certain embodiments, the strategic innovation process 100 may include an alignment phase 110, a research and observations phase 120, a solution agnostic phase 130, a solution generation phase 140, and a solution implementation phase 150. These phases may be performed in the sequence indicated by the solid arrows in FIG. 1, and are discussed in more detail below.

In other embodiments, the phases may be used singly or in combination with the other phases. A non-exhaustive list of example phases and phase sequences follows, and solid and dotted lines indicate various exemplary phase sequence paths in FIG. 1.

In one embodiment, the strategic innovation process 100 may include a single phase, such as the alignment phase 110, the research and observations phase 120, the solution agnostic phase 130, the solution generation phase 140, or the solution implementation phase 150.

In another embodiment, the strategic innovation process 100 may include two phases.

In one example, the alignment phase 110 may be followed by the research and observations phase 120, the solution agnostic phase 130, the solution generation phase 140, or the solution implementation phase 150. In another example, the research and observations phase 120 may be followed by the solution agnostic phase 130, the solution generation phase 140, or the solution implementation phase 150. In another example, the solution agnostic phase 130 may be followed by the solution generation phase 140 or the solution implementation phase 150. In another example, the solution generation phase 140 may be followed by the solution implementation phase 150.

In another embodiment, the strategic innovation process 100 may include three phases.

In one example, the alignment phase 110 may be followed by the research and observations phase 120, and the solution agnostic phase 130, the solution generation phase 140, or the solution implementation phase 150. In another example, the alignment phase 110 may be followed by the solution agnostic phase 130, and the solution generation phase 140 or the solution implementation phase 150. In another example, the alignment phase 110 may be followed by the solution generation phase 140 and the solution implementation phase 150.

In another example, the research and observations phase 120 may be followed by the solution agnostic phase 130, and the solution generation phase 140 or the solution implementation phase 150. In another example, the research and observations phase 120 may be followed by the solution generation phase 140 and the solution implementation phase 150.

In another example, the solution agnostic phase 130 may be followed by the solution generation phase 140 and the solution implementation phase 150.

In another embodiment, the strategic innovation process 100 may include four phases.

In one example, the alignment phase 110 may be followed by the research and observations phase 120, the solution agnostic phase 130, and the solution generation phase 140. In another example, the alignment phase 110 may be followed by the solution agnostic phase 130, the solution generation phase 140, and the solution implementation phase 150.

In one example, the research and observations phase 120 may be followed by the solution agnostic phase 130, the solution generation phase 140, and the solution implementation phase 150.

Other phase combinations and sequences, as well as additional phases, are also supported.

### Alignment Phase

In certain embodiments, the alignment phase may determine target criteria by analytical methods and criteria preference values, determine categories, determine target criteria by team member and stakeholder analysis and profiles, generate rubrics based on profiles (which may include iterative feedback), and evaluate inputs against target success criteria using rubrics, LLM(s), and AI model(s).

For the alignment phase, a team may desire to understand what the target criteria are that would define success of their team. This may include conducting a conjoin analysis or other methodology facilitated by LLMs, ML, and other statistical and AI applications. These applications may be pre-programed with a set of loaded or loadable prompts based on the queries and area of focus defined in advance of, or through, the process. For example, one such analytical method that may be facilitated by Generative AI based query is the Potentially All Pairwise Rankings of All Possible Alternatives (known as “PAPRIKA”). Other analytical methods that may be used to identify the target criteria may include Analytic Hierarchy Process (AHP), Weighted Sum Model (WSM), Technique for Order of Preference by Similarity to Ideal Solution (TOPSIS), Multi-Attribute Utility Theory (MAUT), Elimination and choice expressing reality (known as “ELECTRE”), Conjoin Analysis, ANOVA, Analytic Network Process (ANP), Grey Relational Analysis (GRA), Vlsekriterijumska optimalisacija i kompromisno resenje (known as “VIKOR”), Fuzzy Set Theory (FST), Data Envelopment Analysis (DEA), as well as other methods. Generally, a Multi-Criteria Decision Analysis (MCDA) method may be used in combination with questions that the Generative AI system interactively generates to facilitate the process of calculating the preference values (or “part-worth utilities”) of the criteria and levels of the criteria.

These preference values represent the relative importance of each criteria and level to the decision-maker, which may be fed back into the Generative AI system in order to determine categories that may be attractive for innovation based on various sources, such as a specific proprietary database, the LLM's more general model, a non-proprietary database, etc. The output of the alignment phase may include attractive categories identified by the team through their ranking criteria, from other ranking criteria that were pre-loaded from their organization, company, other larger governing body, etc. The output may then be provided as input areas for the next phase of the process. New input areas, such as categories of interest, may be added into the workflow through different mechanisms, such as an additional selection process, manual input from users of the system, manual input by a larger governing body, etc.

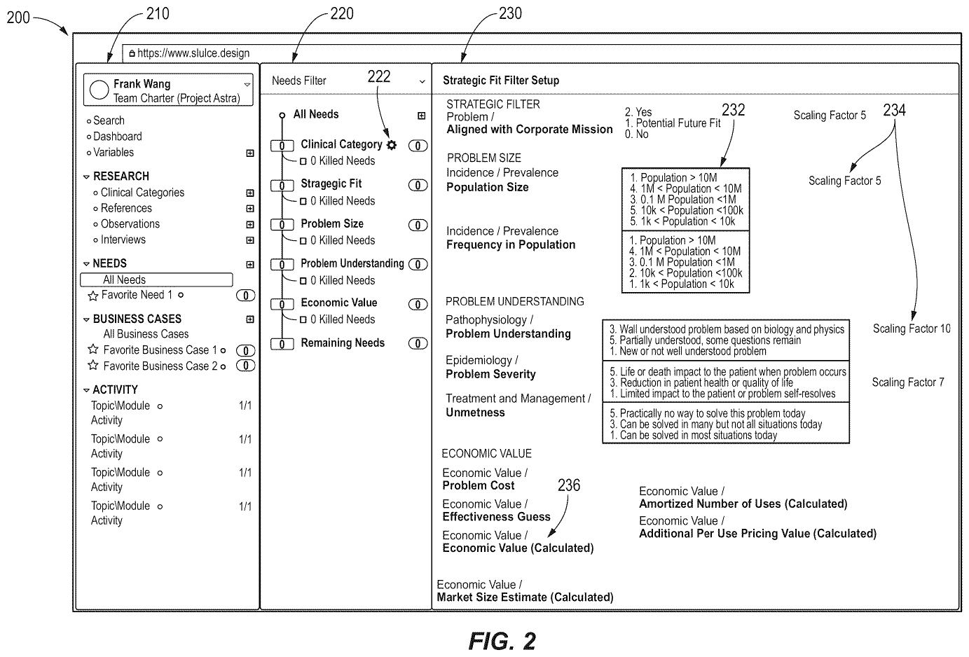

FIG. 2 depicts one view of a user interface 200, in accordance with embodiments of the present invention.

In certain embodiments, the user interface 200 may be a web browser window that includes a navigation index region 210, a needs filter region 220, and a strategic fit filter region 230. The user interface 200 may be hosted by a local computer or a remote network server. Generally, the user interface 200 may be configured to display the software components that implement the strategic innovation process 100. The navigation index region 210 provides a hierarchical list of links to the software components as well as other information. In this view of the user interface 200, the “All Needs” link has been selected, which causes the needs filter region 220 and the strategic fit filter region 230 to be displayed in the window. The needs filter region 220 may include, inter alia, a list of one or more categories 222 that are attractive for innovation, etc. The strategic fit filter region 230 may include, inter alia, ranking criteria 232, weighting criteria 234, financial benefit assessment 236, etc. The needs filter region 220 and the strategic fit filter region 230 may also be known as a ranking entry and filter dashboard.

The preference values may also be used by the system in the previous, current, and later phases to evaluate how well the ideas, concepts, and solutions are aligned with the preference values.

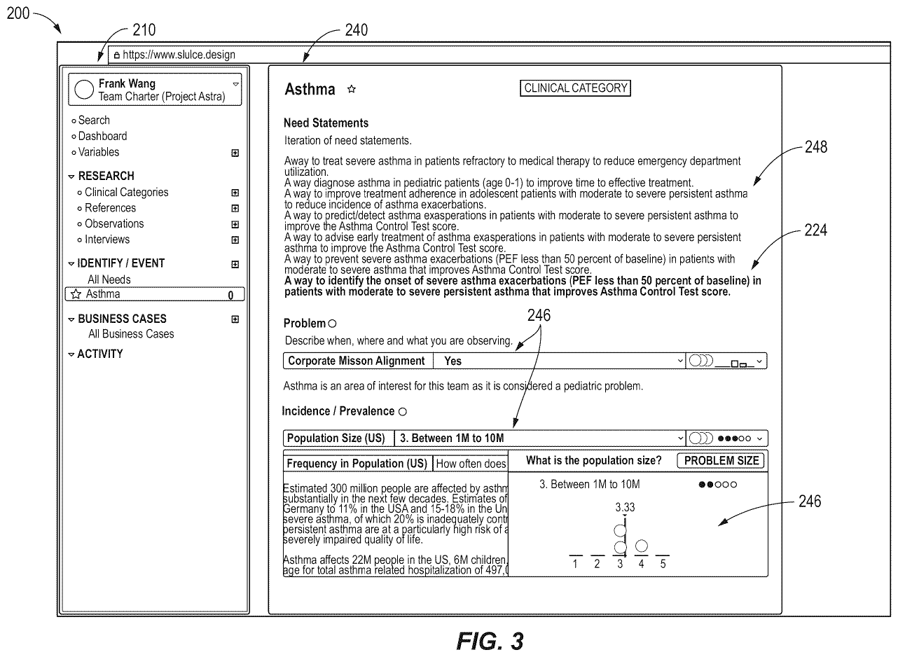

FIG. 3 depicts another view of the user interface 200, in accordance with embodiments of the present invention.

In certain embodiments, the user interface 200 may include the navigation index region 210 and a topic region 240. In this view of the user interface 200, the “Asthma” link has been selected, which causes the topic region 240 to be displayed in the window. The topic region 240 may include, inter alia, preference values 242, need statement 244, ranking criteria 246, etc. Previous versions of the need statement 248 are also displayed. The topic region 240 may also be known as a need statement wiki opportunity identification and articulation module.

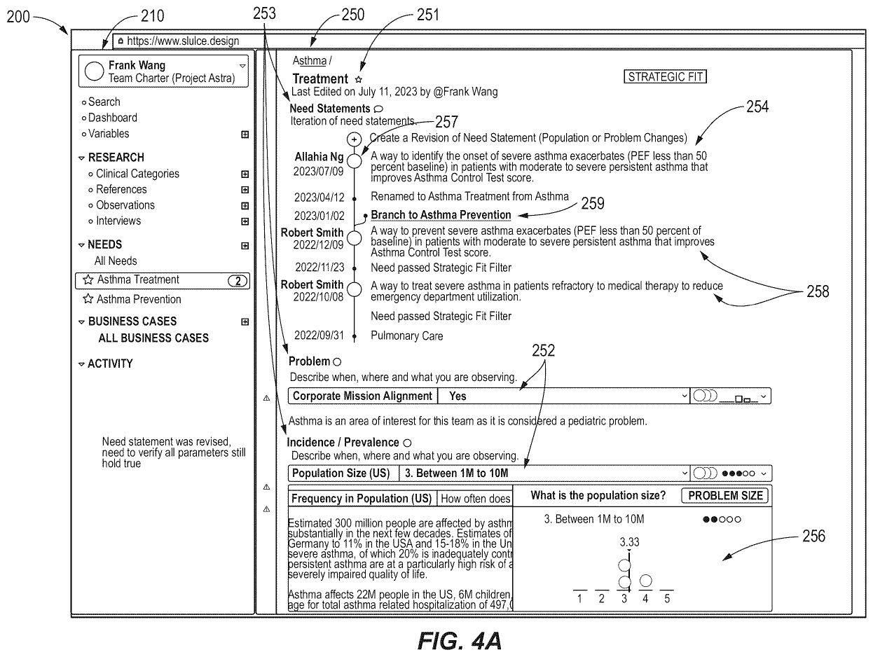

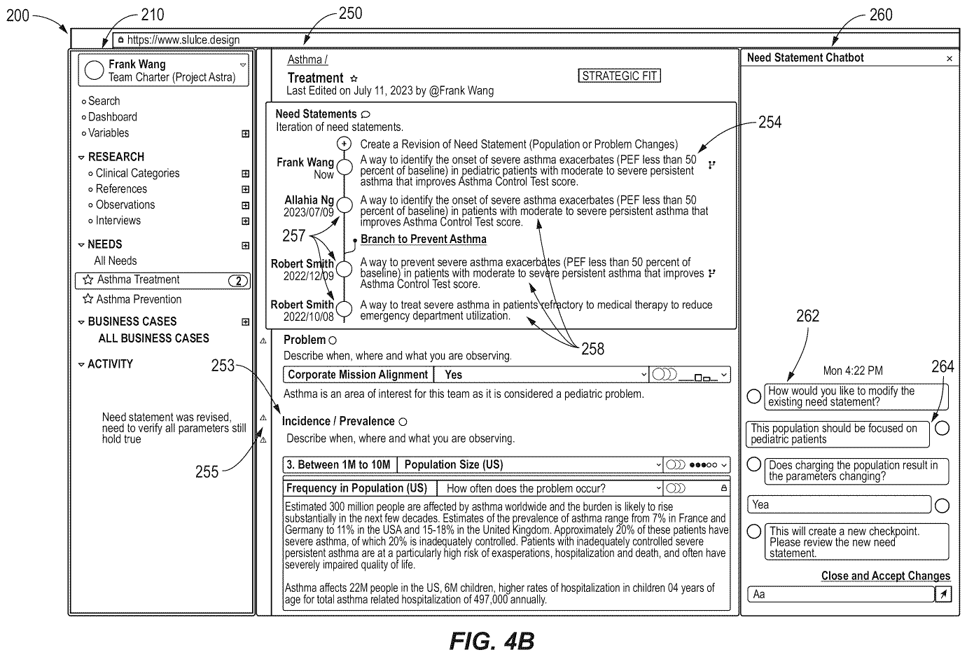

FIG. 4A depicts another view of the user interface 200, in accordance with embodiments of the present invention.

In certain embodiments, the user interface 200 may include the navigation index region 210 and a topic region 250. In this view of the user interface 200, the “Asthma Treatment” link has been selected, which causes the topic region 250 to be displayed in the window. The topic region 250 may include, inter alia, header 251 (such as “Treatment”, etc.), preference values 252, subheaders 253 (such as “Need Statements”, “Problem”, “Incidence/Prevalence”, etc.) need statement 254, ranking criteria 256, etc. The topic region 250 may also include a prompt 255 for the user that indicates additional information may be needed. The topic region 250 may also be known as a need statement wiki opportunity identification and articulation module. The topic region 250 depicts historical editing of the need statements 258 by different users 257, and a branch 259 to other need opportunities.

FIG. 4B depicts another view of the user interface 200 depicted in FIG. 4A, in accordance with embodiments of the present invention.

In certain embodiments, the user interface 200 may include the navigation index region 210, the topic region 250, and a chatbot region 260. The topic region 250 may also include a prompt 255 for the user that indicates additional information may be needed. In this view of the user interface 200, chatbot region 260 depicts historical editing of the need statement 254 using LLM chatbot support. The chatbot region 260 may include, inter alia, output 262 from a need statement chatbot application (such as questions, responses, etc.), and input 264 from a user (such as responses, questions, instructions, etc.). The need statement chatbot application may include, or be coupled to, an LLM that is configured to generate need statements 254 for the topic region 250 based on interactions with the user in the chatbot region 260. In certain embodiments, the user may select a microphone icon in the topic region 250 or the chatbot region 260, and then enter the information by speaking into a microphone coupled to the user's computer. The user interface 200 (or a supporting application, an operating system function, etc.) may perform the speech-to-text translation. In some embodiments, the user may select a camera icon in the topic region 250 or the chatbot region 260, and then enter the information by uploading an image or a video that may be processed by the system. Generally, data may be input through voice, image files, and video files in any of the embodiments of the user interface 200.

In certain embodiments, a method for determining target criteria that define the success for the team may include analyzing the biography, publications, resumes, prior work, chats, emails, conversations, or other type of derivative works of one or more of the team members and stakeholders. One or more LLMs may then generate a profile of an individual user, stakeholder, or an aggregate profile of each user, such as how a typical cardiologist may think, how a typical venture capitalist may think, how an R&D engineer may think, how a marketing and or sales person may think, how a legal expert and or regulatory expert may think, how the company CEO and or members of the executive team or board may think, how an expert or specific person of either of these or other example profiles may respond and think, etc.

The profiles may be used to define the target criteria through the techniques described above, but with minimal or no user interaction. The user may then review and revise the target criteria. Advantageously, the alignment phase is completed sooner using this process, and the user is able to quickly solicit input from a variety of different perspectives simulated by the different generative profiles.

The profiles provide generative iterative feedback that may be used to generate rubrics, such as ranking criteria 232. The rubrics may be derived from the overlapping space of alignment and agreement that each of the different perspective models of stakeholders might find attractive. The rubrics may be used, along with one or more LLMs, synchronized AI models, etc., to evaluate inputs against a target criterion of success from the diverse stakeholders. A similar approach may be used to evaluate solution ideas in the solution agnostic phase, as well as during the research and observations phase, when information stimulus is provided to the models and the rubrics. The models and rubrics may be used to guide rapid iteration and input from simulated stakeholders representing various parts of a business, industry, beneficiary group, customer segmentation and groups, payers, and decision makers at one or more levels of an organization or industry, or within any other part of a stakeholder ecosystem including regulatory and legal professionals.

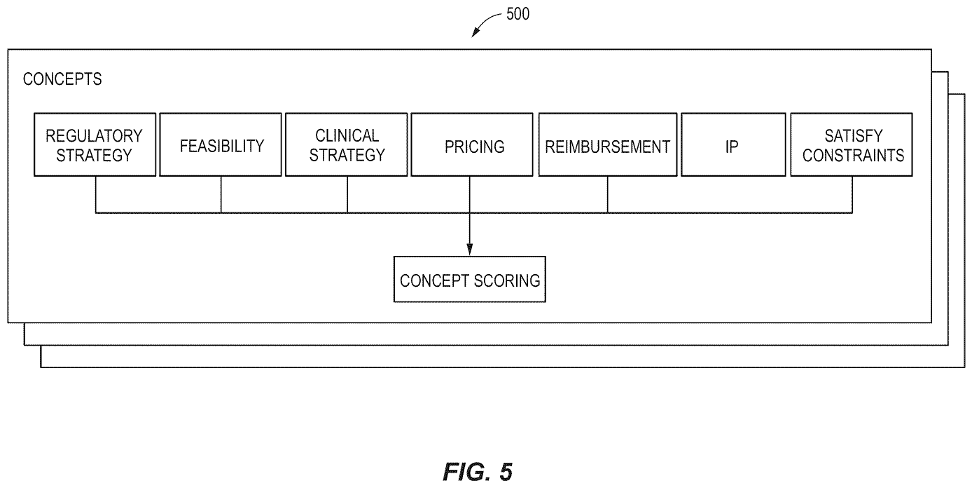

FIG. 5 depicts a concept filtering diagram 500, in accordance with embodiments of the present invention.

In certain embodiments, various concepts may be compared and scored for ranking purposes. The concepts may include such rubrics as regulatory strategy, feasibility, clinical strategy, pricing, reimbursement, intellectual property (IP), constraint satisfaction, etc. The concept filtering diagram 500 may also be known as a scoring matrix for solutions or concepts. Multiple concept filtering diagrams 500 may be generated.

### Research and Observations Phase

In certain embodiments, the research and observations phase may research or map information, generate templates, generate insights, and output opportunity areas. The research and observations phase may also analyze data, link different fields, group data based on themes, and store data for retrieval (such as by generating a knowledge graph, etc.). The research and observations phase may also identify concepts, link concepts with the medical disease and the industry terminology category (as appropriate), and use embeddings to describe the links. The research and observations phase may also project the embeddings onto a different space (such as a disease space, a linkage space, etc.), generate links between ideas (such as existing diseases, other diseases, etc.), and evaluate the quality of the links using LLMs, Generative AI, and known data (such as evaluating the causal links between existing disease and other diseases, etc.). The research and observations phase may also revisit assumptions and insights.

The task of documenting research may benefit from an organizational framework that identifies specific informational elements that are used for the identification of areas of interest in the solution agnostic phase. In the research and observations phase, the users of will be capturing information from a variety of sources in order to identify insights. In certain embodiments, the system may generate a map of areas for research, such as a map of disease areas and their interactions with each other, etc., based on various data sources. The map may provide the user with an area to start looking for opportunities. In other embodiments, the map is not generated. The user would then review one or more of the data sources for insights. The data sources may include academic research papers, focus groups, beta testing, consumer feedback, user reviews, product testing information, observations, ethnographic research, news articles, case or event videos, experiential exercises, regulatory fillings, patent fillings, clinical studies, instructions for use, etc., as well as other kinds of insight capturing activities and techniques. The system may contain a set of templates for the categorization of information. The templates may be generated by the user, generated by an LLM according to specific prompt(s), pre-loaded within the system, augmented or loaded by the user to be customized for their workflow, etc.

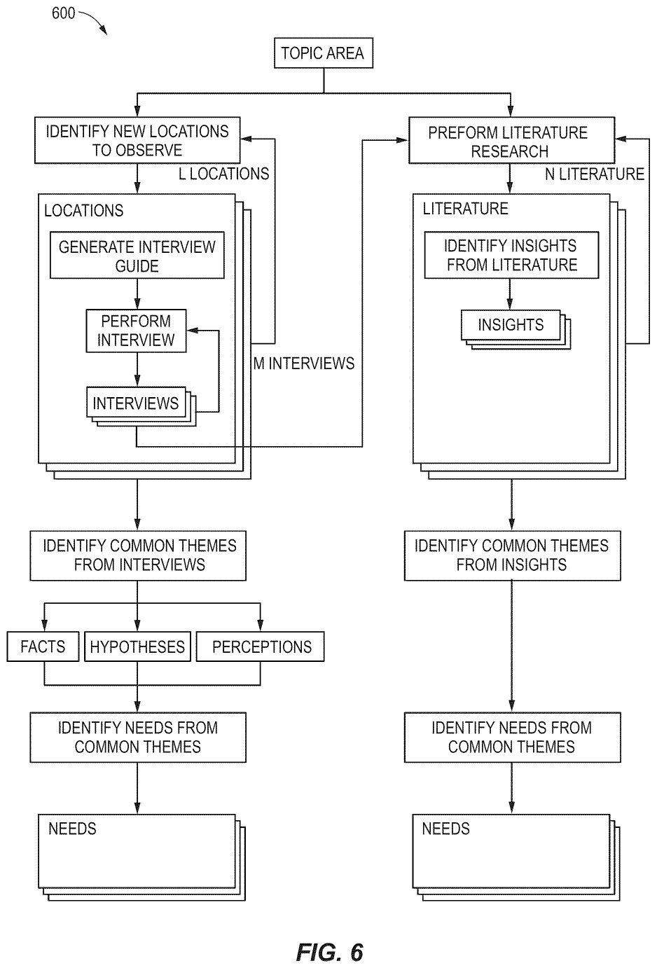

FIG. 6 depicts a process 600 for identifying or creating need statements from literature or interview guide questions, in accordance with embodiments of the present invention.

In certain embodiments, after the topic area has been identified, a new location to observe may be identified. At each location, an interview guide may be generated, and interviews may be performed and documented. After M interviews, a new location to observe may be identified. After the last interview at location L, the common themes from the interviews may be identified, such as facts, hypotheses, perceptions, etc. The needs may be identified from the common themes, and documented.

In certain embodiments, after the last interview at location L, literature research may be performed. In some embodiments, the interviews are not performed, and the literature research may be performed after the topic area has been identified. For each type of literature, insights from the literature may be identified and documented. After N literature types have been researched, the common themes from the literature research may be identified, and insights from the common themes may be identified. The needs may be identified from the common themes, and documented.

In certain embodiments, an interview note sheet may be uploaded to the system, and the responses and notes from the interview may be categorized, by the LLM, into the kind of information that is provided, such as facts, hypotheses, perceptions, questions, observations, etc. A similar categorization may be performed on transcripts of calls, focus groups, videos, user reviews, test documentation reports, as well as other information provided from primary or secondary research on a topic area of interest. This information may form the foundation for observational insights that may be used in the solution agnostic phase to identify insights and subsequent opportunity areas.

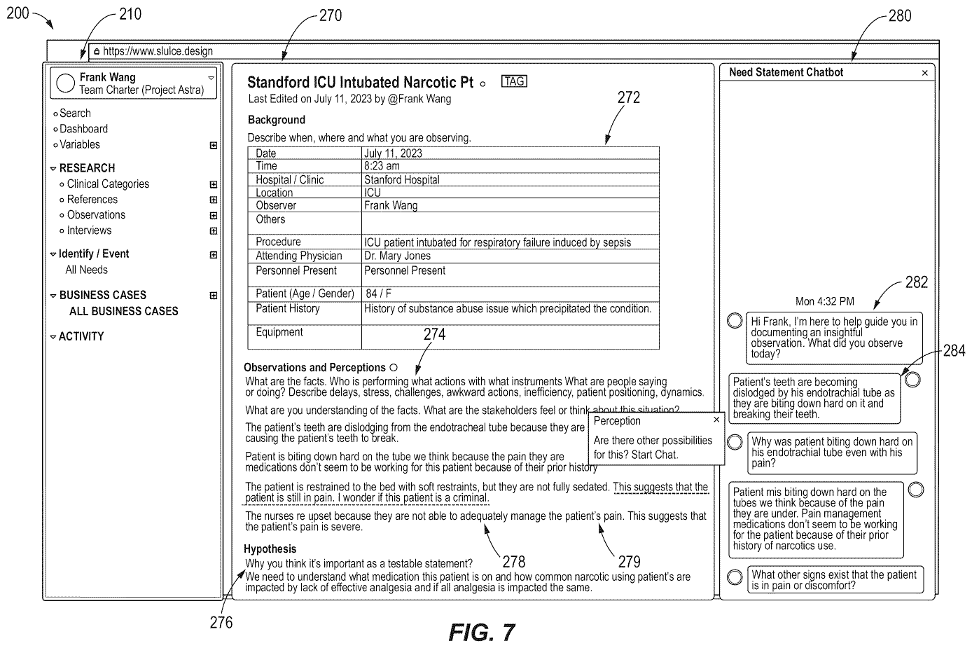

FIG. 7 depicts another view of the user interface 200, in accordance with embodiments of the present invention.

In certain embodiments, the user interface 200 may include the navigation index region 210, a topic region 270, and a chatbot region 280. In this view of the user interface 200, the topic region 270 may include, inter alia, a background section 272, an observations and perceptions section 274, a hypothesis section 276, a modification 278, an observation 279, etc. The observations and perceptions section 274 may include facts, observations, and perceptions, while the hypothesis section 276 may include hypotheses. The chatbot region 280 may include, inter alia, output 282 from an observations chatbot application (such as questions, responses, etc.), and input 284 from a user (such as responses, questions, instructions, etc.). The observations chatbot application may include, or be coupled to, an LLM that is configured to generate information for the topic region 270 based on interactions with the user in the chatbot region 280. This view of the user interface 200 may also be known as an observation module with LLM chat interaction that assists in the curation of facts, perceptions, and questions, and offers follow up questions and interactions.

Many insights may result from combining ideas from different areas or fields, as well as applying the principles from one field to another. Potential linkages between different fields may advantageously be identified using AI systems, such as Generative AI tools, LLMs, etc., that analyze data from various data sets and group them based on common themes. The concepts may then be embedded. Knowledge graph databases and knowledge graph query languages may facilitate the storage and retrieval of the information.

In certain embodiments, one or more data sets may be normalized (alone or in combination) to standardize the use of a common vocabulary and the connection between different vocabulary terms. Exemplary data sets are described below.

In the healthcare industry, the data sets may include the Unified Medical Language System (UMLS), SNOMED CT, RxNorm, LOINC, MeSH, CPT, ICD-10-CM, MedDRA, Human Phenotype Ontology, HL7, FHIR, CDA, CCD, DICOM, etc.

In the energy industry, the data sets may include Energy Glossary by SLB, the U.S. Energy Information Administration (EIA) Glossary, Enverus' Energy Industry Terms Glossary, EPA terminology, DOE terminology, advanced energy vocabularies associated with biofuel and biomass energy, proprietary vocabulary standards for the Oil & Gas industry (such as POSC Epicentre and Schlumberger vocabularies), etc.

In the Military Industry, the data sets may include the DoD Dictionary of Military and Associated Terms, the Terminology Repository for DoD Issuances, the USG Compendium of Interagency and Associated Terms, NATO Terminology, etc.

In the consumer product industry, the data sets may include UL terminology, HS Code, Consumer Product Safety Commission Dataset, CFR indexing terms, etc.

In the education industry, the data sets may include CIP Codes (classification of instructional programs), NCES Glossary, NPEFS, PSS, FS, CCD-Nonfiscal, CCD-F-33, CCD-TCS, COD System, CSPR, CBE, ECLS, EDFacts, ELS:2002, EADA, DDI, CTAC Evaluation, Evaluation of the RELs, FRSS, FFEL/Direct Loan CDR, Pell Grant Reporting, Federal Perkins Loan Program, FG, FAFSA, GE, GFSA Reports, HS&B, HSLS:09, IDEA Part B SPP/APR, IDEA Part C SPP/APR, IDEA Section 618, RTT-SIG Impact Evaluation, TLES, Impact Evaluation of Training in MTSS-B, Title I/II Implementation, TSFG, IPEDS, MRSDT, NAEP, NELS:88, NHES, NLS-72, NLTS2, NPSAS, NSLDS, NSOPF, NTPS, PEPS, PEQIS, PEELS, PCER, PSS, PD Impact, PISA, PIAAC, PIRLS, PLS, SSOCS, SASS, REL Southeast, StLA, SDET, TSA, TALIS, TIMSS, etc.

In certain embodiments, an LLM may identify each concept within a dataset according to the common vocabulary. The LLM may also identify an aligned category segment that is associated with each concept. In other embodiments, a common vocabulary may not be provided, and clusters may be formed in the embedding space, such as by determining a cosine distance to represent a common theme, etc.

In the medical field, an LLM may identify the link between the concept and disease, and embedding may be used to describe the links between the concept and disease. The embedding may be projected onto different dimensions according based on a group strategy, or, alternatively, through a dimension reduction step. The similarity of the links between different concepts and disease may be measured through Euclidean distance, cosine distance, dot product, etc.

Sentence or paragraph embeddings may not capture the nuances of the specified text. For example, “mechanism of action for diabetes” vs “how chronic kidney disease arises” can be very similar and very different depending on interpretation. For example, if the user is searching for just diseases, diabetes and chronic kidney disease (CKD) are very different. However if the user is searching for various mechanisms of action, then these two sentences are quite similar.

An LLM may be used to break the sentence or passage of text to multiple sub-components. To identify the link between the subject and the predicate, the LLM may identify the subject and remove it, or replace it with asterisks or other text. In the previous example, the resulting text would be “mechanism of action for ********” and “how ******** ******** ******** arises”. Then, a new set of embeddings may be generated for these new sentences. The new embeddings may have metadata that include the original sentence, the embeddings, a combination of the original sentence and the embeddings, etc. The LLM may identify the subject and mask everything else, so that, in the previous example, the resulting text would be “******** *** ******* *** diabetes” and “**** chronic kidney diseases ********”. The LLM may then generate another set of embeddings. Like the previous embeddings, these new embeddings may have metadata that include the original sentence, the embeddings, a combination of the original sentence and the embeddings, etc.

These techniques may also be applied to other industries with standardized (or non-standardized) terminology, such as the military industry, the education industry, the consumer products industry, the energy industry, the materials industry, the media and film industry, the fashion industry, the automobile and transportation industry, the supply chain and logistics industry, the aerospace industry, the telecommunications industry, the semiconductor and electronics industry, the internet, the software industry, etc.

The nuances of the sentence or passage of text may also be understood by projecting the embeddings onto a different space. For example, single or multiple embeddings may be generated, and then projected onto the disease space. In the previous example, the CKD embeddings may be very distinct from the diabetes embeddings. However, if the embeddings are projected onto a linkage space, then “MOA” and “How arises” may be grouped very similarly. This embedding concept is not limited to just causal relationship, but may also be applied to group similar mechanisms of action together, such as asthma attack vs COPD (caused by inflammation of the lungs).

Linkages between various ideas may also be generated through genetic algorithms, and an LLM (or other AI system) may evaluate the generated linkages based on known publications and datasets. In one example, a simulated annealing algorithm is used. Given an existing disease, a disease may be randomly selected from a known dataset, such as from ICD, HCUP, reimbursement data, etc. The selection of the random disease may also account for incidence rate, prevalence rate, cost of disease, ethnicity, as well as other factors. The causal link between the existing disease and the randomly-selected disease may be generated, or, alternatively, determined through traditional search algorithms, categorization algorithms, LLMs, embedding, etc. The disease with the causal link may be evaluated by an LLM to determine how likely it is true, and the acceptance criteria progressively may become increasingly more stringent as the number of iterations are increased. The process is repeated continuously for the next causal link until the quality of the link, as determined by the LLM, cannot be improved past the preset tolerance. The process may then be repeated multiple times in order to determine probable insights across different disease states. Advantageously, the process uncovers insights that a user without interdisciplinary knowledge may not have found.

Insights may also be found by revisiting assumptions behind current standards of practice. When a technique or procedure is so commonly accepted to the point where users don't know the reasoning behind it, this indicates that the standard of practice may be ready for re-evaluation. For example, assumptions that were made when the standard of practice was defined might have changed with new technology or research.

### Solution Agnostic Phase

In certain embodiments, the solution agnostic phase identifies best unmet needs of stakeholders, identifies outcomes defining objectives of stakeholders, generates statements (such as a need statement, a problem statement, etc.), guides the generation of statements using LLM(s) and interactive user input, and revises the statements based on additional user input. The solution agnostic phase also generates the environment for the need statement, the stakeholders for the environment, and the objective criteria for stakeholders, and generates market specific criteria. The solution agnostic phase also defines a financial value based on a successful need statement outcome, generates a financial metric for a viable solution based on the financial value, determines the available execution time window, and adapts objective criteria to the time window. The solution agnostic phase also provides a concurrent analysis of statements, environments, stakeholders, objective and market criteria.

In certain embodiments, the solution agnostic phase identifies the best unmet needs, which may be defined as problems, needs, issues, etc. of a population of stakeholders that have an outcome that defines an objective of the stakeholders. The objective indicates that the problems, needs, issues, etc. have been ameliorated, solved, lessened, or otherwise positively impacted. These elements may be combined into phrases and sentences that describe the unmet need to be solved. The phrases and sentences may be formed into various statements, such as a need statement, a problem statement, an opportunity statement, a “how might we” statement, a customer pain point, a customer need, a user requirement, a business requirement, a functional requirement, a non-functional requirement, a value proposition, a design brief, a statement of work, a product requirements document, a user story, an acceptance criteria, a success metric, a key performance indicator (KPI), etc. The statements may be represented in various ways, such as a graphical interface, a picture or image, a sketch, a business model canvas, a customer journey map, etc.

For example, FIG. 3 depicts the need statement 244 as well as previous iterations of the need statement 248. FIG. 4A depicts the need statement 254 as well as historical editing of the need statements 258 by different users 257. FIG. 4B depicts the need statement 254, historical editing of the need statements 258 by different users 257, as well as editing of the need statement 254 using LLM chatbot support.

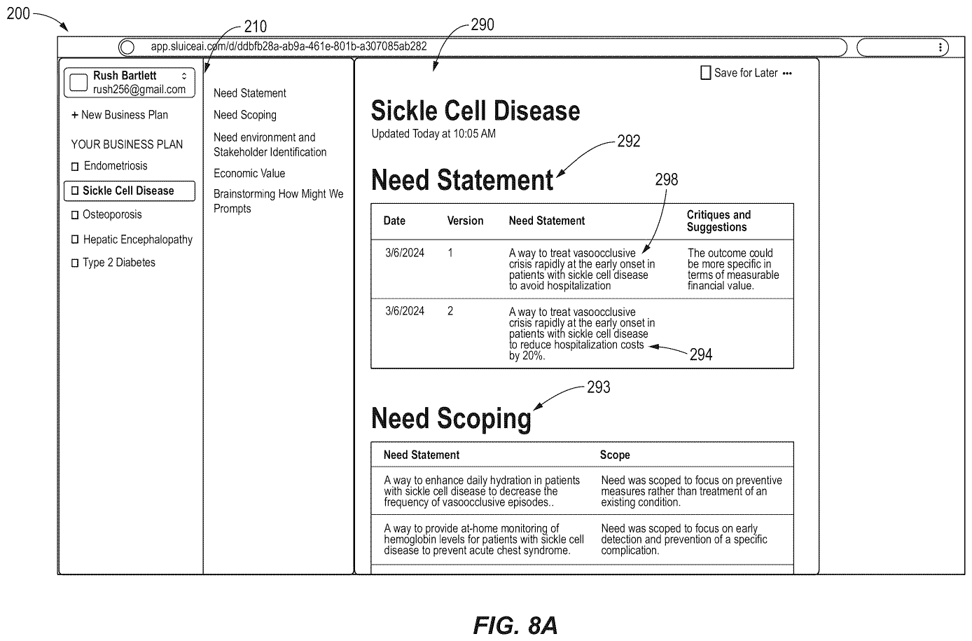

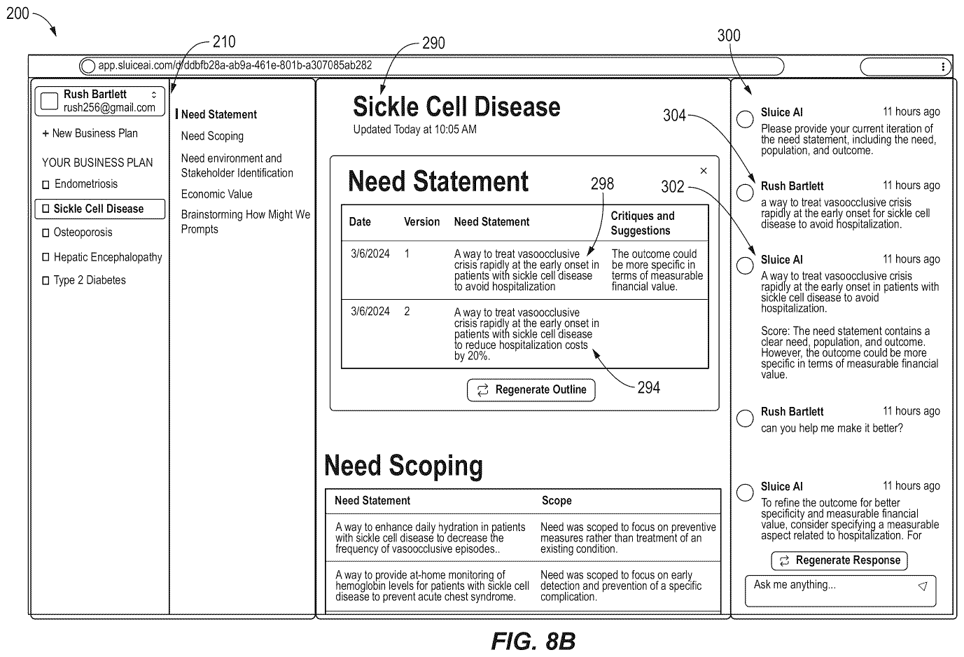

FIG. 8A depicts another view of the user interface 200, in accordance with embodiments of the present invention.

In certain embodiments, the user interface 200 may include the navigation index region 210 and a topic region 290. In this view of the user interface 200, the topic region 290 may include, inter alia, a need statement section 292, a need scoping section 293, etc. The need statement section 292 may include a need statement 294, previous need statement(s) 298, etc. This view of the user interface 200 may also be known as a generative AI and human co-created document template summary.

FIG. 8B depicts another view of the user interface 200 depicted in FIG. 8A, in accordance with embodiments of the present invention.

In certain embodiments, the user interface 200 may include the navigation index region 210, the topic region 290, and a chatbot region 300. In this view of the user interface 200, chatbot region 300 depicts editing of the need statements 294, 298 using LLM chatbot support. The chatbot region 300 may include, inter alia, output 302 from a need statement chatbot application (such as questions, responses, etc.), and input 304 from a user (such as responses, questions, instructions, etc.). The need statement chatbot application may include, or be coupled to, an LLM that is configured to generate need statements 294, 298 for the topic region 290 based on interactions with the user in the chatbot region 300. This view of the user interface 200 may also be known as a need statement section summary with chat interaction. Another chatbot application may receive the chat interaction (or conversation), and then curate the need statement table and the response in the need statement section summary.

The solution agnostic phase the LLM to write, curate, guide, question, and otherwise facilitate the generation of the phrases and sentences that describe the area of interest, such as a need statement, etc. Notably, the solution agnostic phase avoids promoting specific technological approaches and specific solutions. While the mechanism of action and other specific descriptors of the problem may be used, the tool by which the mechanism of action or problem is addressed is minimized in the evaluation of the solution agnostic phase.

In one example, the user enters text that represents a need statement that is constructed to address a problem for a population, the solution of which achieves a measurable and valuable outcome. If the text does not contain a population, the LLM may suggest several such populations, and may ask the user further questions to guide the notation and selection of one or more populations, as depicted in the chat interaction in the chatbot region 260 of FIG. 4B. Each iteration of this process may be presented to the user. The user may then chose to manually edit, capture, or discard the constructed sentence in a further table, list, tree, or graph to be used later in the evaluation and selection portions of the need statement process. This methodology may be used for other statements as well.

Several tools may be used to articulate the need statement, such as a wiki guidance template, a pre-populated web page supported by data generated by the LLM, inputs generated by the users, loaded inputs from previously recognized need statements, etc. In certain embodiments, an opportunity area may be developed in anticipation of the articulation of the need statement.

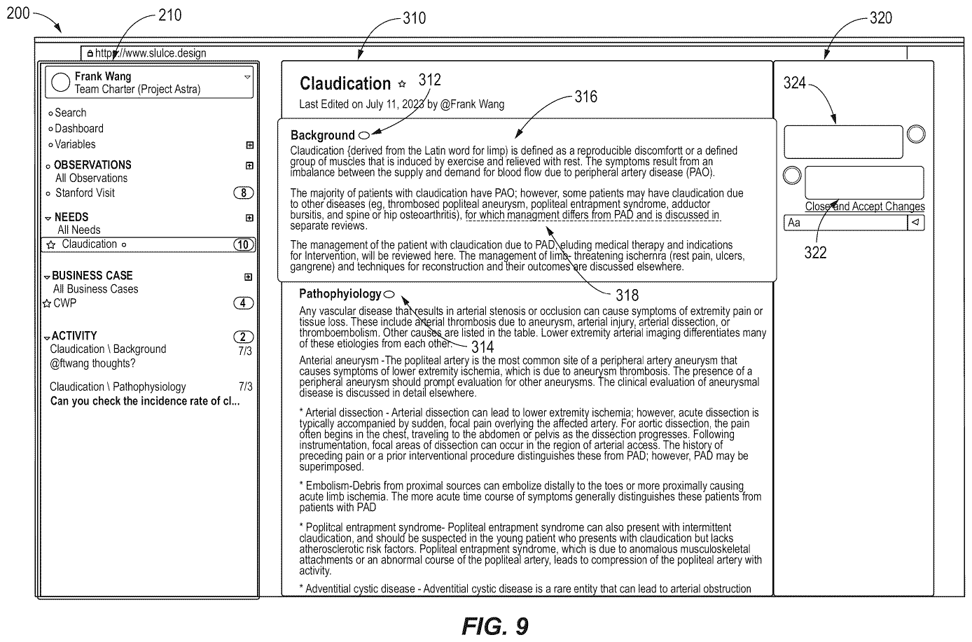

FIG. 9 depicts another view of the user interface 200, in accordance with embodiments of the present invention.

In certain embodiments, the user interface 200 may include the navigation index region 210, a topic region 310, and a chatbot region 320. In this view of the user interface 200, the topic region 310 may include, inter alia, a background section 312, a pathophysiology section 314, etc. The topic region 310 may include LLM-created data 316 as well as user-created data 318. The chatbot region 320 may include, inter alia, output 322 from a chatbot application (such as questions, responses, etc.), and input 324 from a user (such as responses, questions, instructions, etc.). The chatbot application may include, or be coupled to, an LLM that is configured to generate information for the topic region 310 based on interactions with the user in the chatbot region 320. This view of the user interface 200 may also be known as a wiki for an opportunity area including LLM chat interface.

The need statement, and variations of the need statement, may be determined from the differences in the problem to be solved, the need underlying that problem with an action to be taken, a population that is experiencing the need (such as stakeholders), and one or more outcomes that are valuable and demonstrate a positive signal.

The need statements may be prioritized to provide a ranking criteria such that the users and the LLM may guide the selection of the most attractive need statement. The ranking criteria may be include inputs or filter criteria selected from the alignment phase, manually-inputted filter criteria, pre-loaded filter criteria from a set of standard or customized templates, etc. For example, FIG. 2 depicts ranking criteria 232 developed during the alignment phase. The filter criteria assist the prioritization of the need statements, and may be selected by the user based on a score, or, alternatively, may be selected by the system. The filter criteria may be generated in several different ways. In certain embodiments, questions associated with the filter criteria may be presented, and the answers provided to the questions may determine the filter criteria. For example, the LLM may generate data to automate the process of answering the filter criteria questions. In another example, answers to the filter criteria questions may be determined by inspecting historical data set for similar need statements, by inspecting historical data set for similar filter criteria questions, by user input, etc.

The LLM (or other AI system) may then calculate an ideal accuracy and confidence metric to the answers provided, and then display the ideal accuracy and confidence metric next to the answer to the filter question. The user may then adjust the answer in the case that the user did not like the LLM response, adjust the threshold of the confidence metric that the LLM would require to answer a question based on a single question basis, a single filter level basis, etc.

For example, the user may accept a lower confidence answer from the LLM in the first few filter questions, and then require that the accuracy and confidence of the information increase before an answer from the LLM is allowed when answering questions about a narrower set of needs. Similarly, the user may accept a lower confidence answer from the LLM for more qualitative filter questions applied to a basket of needs to be prioritized, and then require that the accuracy and confidence of the information increase. The user may eventually require that the LLM confidence is very high before an answer is included from the LLM in the weighting criteria for the question. FIG. 2 depicts exemplary weighting criteria 234. Additionally, if the LLM does not reach the threshold criteria, then an answer may be withheld from the scoring matrix on the prioritization of the needs, or the user may be asked to supply additional information that the LLM would require in order to increase the accuracy, as indicated by prompt 255 depicted in FIG. 4B. For example, the LLM may ask the user multiple-choice questions, ask the user to type free text, ask to the user to provide additional references, etc. The inclusion of this information may increase the confidence such that the LLM may then rank the specific criteria. If the LLM is not able to rank the specific criteria based on the confidence, then the user may rank the criteria based on a complete filter column question, an individual need, etc. In certain embodiments, after the need statement has been selected, the solution generation phase may begin.

When a need statement (or similar description of opportunity) has been developed, one or more environments in which it is possible to solve the need may also be determined, and then a set of stakeholders under each environment may be determined. The stakeholders may be present in more than one environment, and may include the person or entity with the need, the user, the decision maker, the person who will pay for the solution to be used to solve the need, etc. A set of objective criteria may be determined for each stakeholder. In certain embodiments, the objective criteria may be determined based on the LLM's model, which may be supplemented with customized data sets, such as focus group data, survey information, stakeholder specific data (such as regulatory guidance, standards based documentation representing the voice of one or more stakeholder groups, etc.), etc. A potential solution to the need statement is considered to be viable when the solution satisfies these objective criteria.

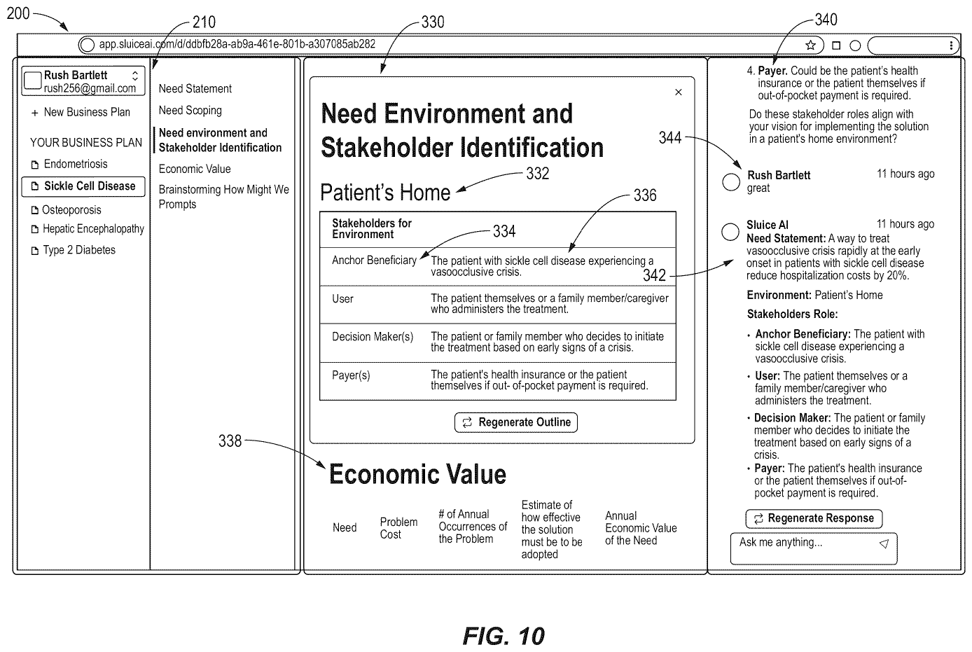

FIG. 10 depicts another view of the user interface 200, in accordance with embodiments of the present invention.

In certain embodiments, the user interface 200 may include the navigation index region 210, a topic region 330, and a chatbot region 340. In this view of the user interface 200, the topic region 330 may include, inter alia, an environment section 332 (such as “Patient's Home”), a economic value section 338, etc. The environment section 332 may include one or more stakeholders 334 and the stakeholder's objective criteria 336, etc. The chatbot region 340 may include, inter alia, output 342 from a chatbot application (such as questions, responses, etc.), and input 344 from a user (such as responses, questions, instructions, etc.). The chatbot application may include, or be coupled to, an LLM that is configured to generate information for the topic region 330 based on interactions with the user in the chatbot region 340. This view of the user interface 200 may also be known as a need environment and stakeholder identification summary with chat interaction view. Another chatbot application may receive the chat interaction (or conversation), and then curate the information in the chat to be used as the summary output for the need environment and stakeholder identification summary.

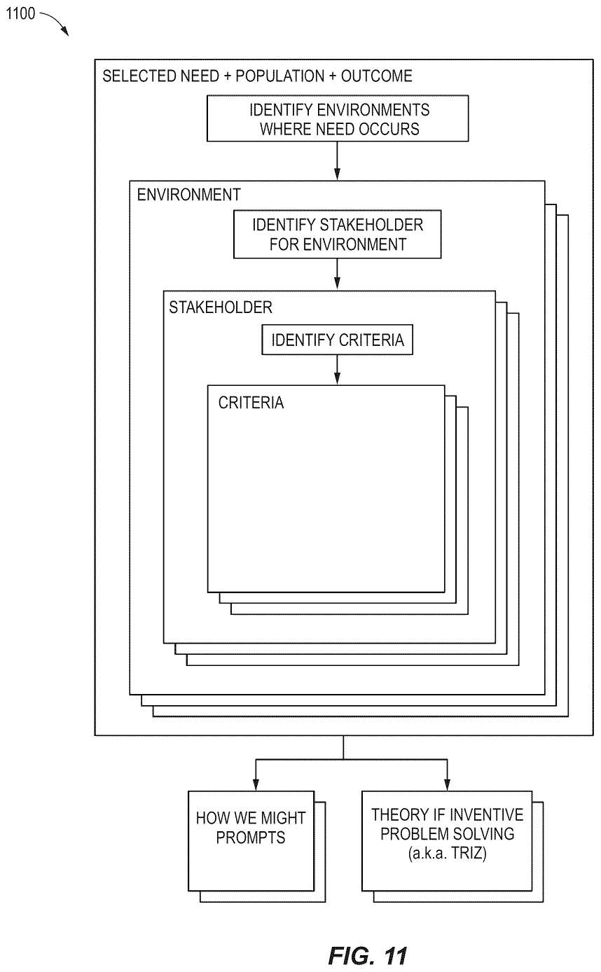

FIG. 11 depicts a process 1100 for developing a solution to solve a need statement, in accordance with embodiments of the present invention.

In certain embodiments, after the need statement, population and selected outcome have been determined, one or more environments in which it is possible to solve the need may be identified, and then a set of stakeholders under each environment may be identified. The set of objective criteria for each stakeholder is then identified. After all of the sets of objective criteria have been determined, the solution may then be identified through various processes, such as “how we might” prompts from the LLM, the theory of inventive problem solving, etc.

In certain embodiments, the objective criteria may be provided as boundary conditions for the solution identification process, such as what a solution must achieve, from what a preferred solution may benefit, etc. The solution identification process may include an LLM that may be combined with another discrete database of concepts and technologies, and may apply descriptors to the objective criteria. The solution identification process uses the objective criteria as context for the LLM, which determines whether those description embeddings are close to the desired criteria embeddings

The objective criteria may also be determined by analyzing competitor products, such as specifications, manuals, consumer complaints, reviews, regulatory filings, other information, etc. In addition to the objective criteria, a set of market specific criteria based on non-stakeholder factors may be determined. The market specific criteria may include, inter alia, laws and regulations, competitive barriers to entry (such as patent information, channel control of a monopoly, etc.), etc.

Other areas, such as an assessment of the financial benefit or economic value, may be imparted on the stakeholders when the described need or opportunity is achieved, such as when a need statement outcome is met. In this way, achievement of the need statement outcome defines the amount of financial value that may be generated. Thus, the magnitude of the financial value may be a boundary condition for a financial metric that defines a viable solution, as opposed to a non-viable solution that does not generate the financial value.

Additionally, a market analysis of competitive launch timing and key events may contribute to an understanding of the amount of time that may be available before it is likely that the objective (or opportunity) criteria changes. In certain embodiments, an execution window may be determined that defines the amount of time that the solution may need in order to be successful.

For example, during the height of the COVID19 epidemic, vaccines would come to fruition that would significantly reduce or eliminate many of the medical needs that were caused by the COVID19 epidemic initially. Thus any idea that was meant to have an impact on the downstream medical needs needed to get to market and make an impact within a short period of time. In a similar scenario, the LLM and supplemental data sets may take into account clinical trial information of the vaccine manufacturers, as well as other likely timeline information, and may result in a significant change to the market dynamics and the objective criteria. Additionally, a forecast relating to what changes to the objective criteria, financial criteria, market criteria, and other boundary conditions will develop over time may be performed, and a cross match with the expected length of development for a solution, based on the users input, LLM assessment, and the historical track record of the innovation organization or individual in delivering a product to market, may be determined. The objective criteria may then be adapted to the market requirements at the time when the solution is likely to get to the market.

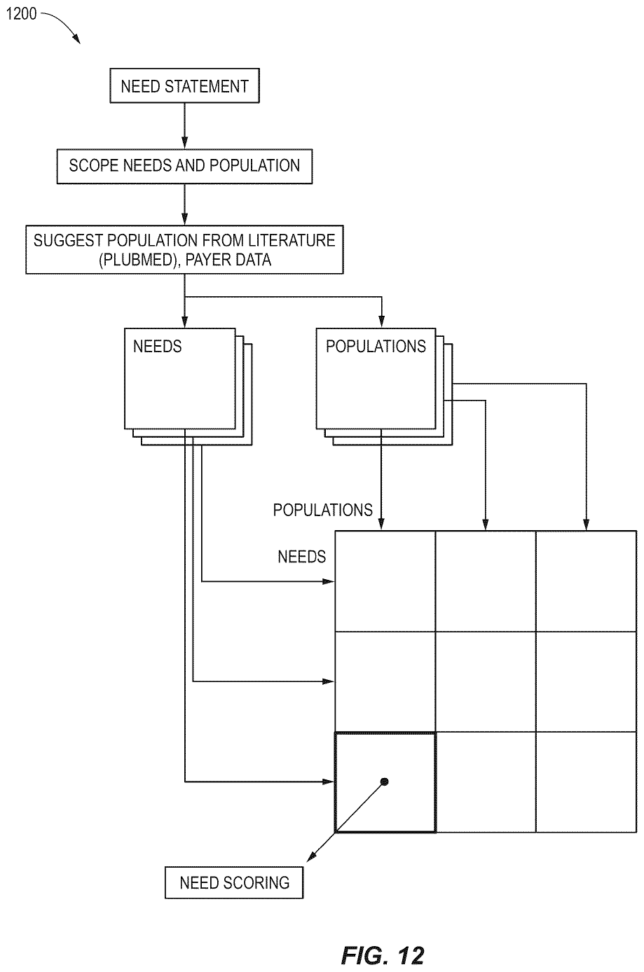

FIG. 12 depicts a process 1200 for developing a scoring matrix for a need statement, in accordance with embodiments of the present invention.

In certain embodiments, the scope of the needs and the population are determined from the need statement. A suggested population is then determined from literature, such as PubMed, payer data, etc. A number of needs and a number of populations are then determined from the needs scope and the suggested population. A scoring matrix is then formed based on each need and each population. Each need is paired with each population, and a need score is determined for each pair.

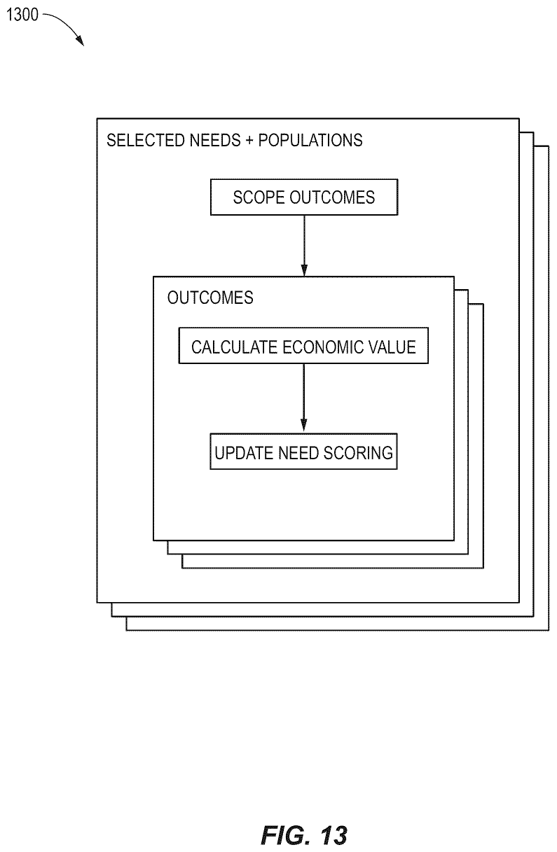

FIG. 13 depicts a process 1300 for updating the need scoring, in accordance with embodiments of the present invention.

For each need and population pair, the scope outcomes are determined. For each outcome, a criteria is determined, such as calculation of the economic value, and the need scoring is updated. Scoped outcomes may change the scoring based on the different outcomes.

Need statements and other opportunity definition statements, their environments, stakeholders, objective and market criteria, legal and regulatory constraints, as well as other factors, may depend upon each other. Variation in this information may be concurrently analyzed such that competition may drive the selection of the best overall combination of factors.

### Solution Generation Phase

In certain embodiments, the solution generation phase generates a description of solutions, generates solution groups (such as groups of solution types, groups of solution classifications, groups of mechanisms of action, etc.), and classify solutions into one or more solution groups (such as a pharmaceutical solution in the type of solution group, etc.). The solution generation phase also ranks solutions against criteria, evaluates solutions against one another, determines the degree of fitness of each solution, determines a landscape of fitness, and selects a solution for implementation.

Generally, the solutions may be described in different ways, such as concepts, embodiments, ideas, thoughts, technologies, approaches, opportunities of need, etc.

In certain embodiments, the solution may be expressed as a word, a phrase, a sentence, a paragraph, short prose, etc. that describes the product, method, service, etc. that solves the need. The solution may also be expressed in different forms, such as a concept-embodiment pair, a business model and solution pair, an embodiment, a concept, a solution, an idea, an invention, a minimum viable product, a final product, a solution tree, a solution set, a prototype, etc. The solution may be expressed in a graphical interface, as a picture or image, as a sketch, a business model canvas, in a customer journey map, in a “how might we” statement, as a mind map, etc. These expressive elements may be used alone or in combination, and may be generated by the users as well as an LLM.

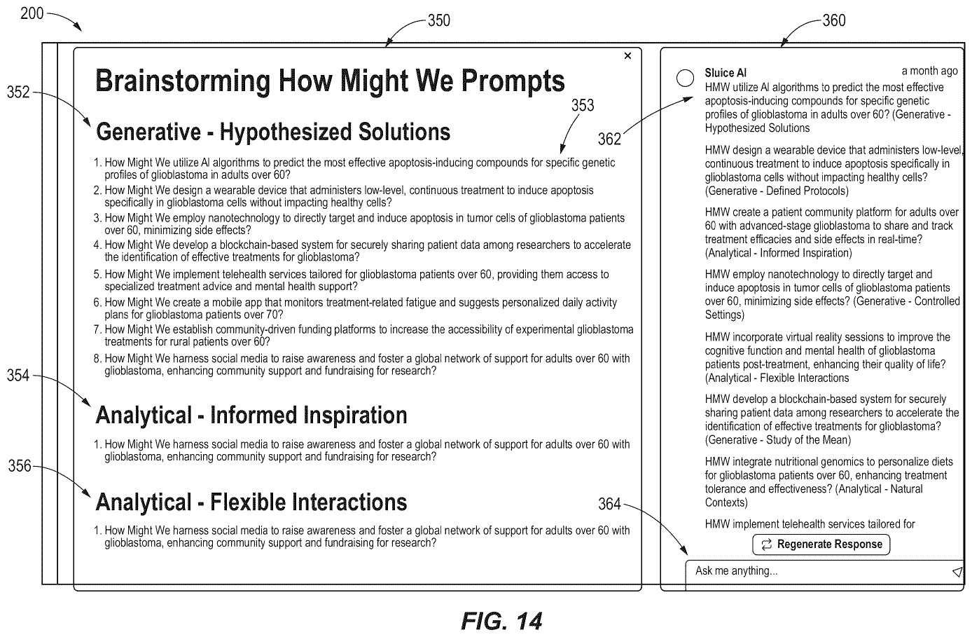

FIG. 14 depicts another view of the user interface 200, in accordance with embodiments of the present invention.

In certain embodiments, the user interface 200 may include the navigation index region 210 (not depicted), a topic region 350, and a chatbot region 360. In this view of the user interface 200, the topic region 350 may be directed to brainstorming “how might we” prompts or statements, and may include, inter alia, a generative hypothesized solution section 352 including “how might we” statements 353, an analytical informed inspiration section 354, an analytical flexible interactions section 356, etc. The chatbot region 360 may include, inter alia, output 362 from a chatbot application (such as questions, responses, etc.), and input 364 from a user (such as responses, questions, instructions, etc.). The chatbot application may include, or be coupled to, an LLM that is configured to generate information for the topic region 350 based on interactions with the user in the chatbot region 360, such as the “how might we” statements 353.

In certain embodiments, the solutions may be grouped based on one or more dimensional characteristics.

In one example, the solutions may be grouped based on type, such as a service offering, an electrical solution, a chemical solution, a pharmaceutical solution, a mechanical solution, etc. In another example, the solution may be grouped based on use, such as a one-time (or disposable) solution, a reusable solution, a hybrid solution, etc. In another example, the solution may be grouped based on classification, such as a blue sky solution, an incremental solution, a step change solution, etc. In another example, the solution may be grouped based on mechanism of action.

One mechanism of action group may include Gabapentin, a Vegas nerve stimulator, etc. Gabapentin works by reducing the flow of calcium into neurons and thus reduces the activity of neurons for nerve related problems, while a Vegas nerve stimulator acts on neurons to reduce their activity. Another mechanism of action group may include nitric oxide, a stent, balloon angioplasty, a bypass vessel or graft, etc. Nitric oxide works to dilate blood vessels to increase blood flow. A stent and a balloon angioplasty work to physically increase the diameter of the blood vessel to increase blood flow, while a bypass vessel or graft increases blood flow by providing an unobstructed flow path. Advantageously, different technologies that have similar mechanisms of action may be grouped together.

Although the solutions in each group may not present the same biochemical or physical mechanism of action, the solutions do create the same mechanism of action against the overall problem, which may be a nerve disorder, a blockage or constriction or ischemia in one or more tissues that can be resupplied by additional blood flow, etc.

The solutions may be ranked against one or more filter criteria, such as boundary conditions determined in the solution agnostic phase, filter criteria that are generated by an LLM, filter criteria that are input by a user, etc. The filter criteria may be generated based on an understanding of desired traits for the selected solution, criteria defined in the alignment phase, etc. The filter criteria form the dimensional constraints that may be used to evaluate the attractiveness of one solution over another.

After the solutions are evaluated, the degree of fitness to satisfy the criteria of one of the solutions may be determined, and the LLM may suggest adjustments to the solution to improve the fitness of the solution in order to achieve the criteria in a best mode of action. In some embodiments, the user may suggest adjustments to the solution to improve the fitness of the solution.

In one example, if a criteria requires the opening of a blocked blood vessel and subsequent maintenance, a solution that uses a balloon to dilate and open the vessel may be evaluated as a weak fit. However, a solution that combines the balloon with a stent or other structural support to maintain the opening of the vessel after the balloon is removed may be evaluated as a strong fit.

Similar to the prior phases, when presented with a scenario that lacks information or lacks confidence in the information to make a determination, the LLM may ask the user for input. Additionally, the LLM may ask the user for input at different times regardless of the confidence level. Advantageously, the user may make a final determination based on the confidence level, which may be supplemented with other information provided by the LLM. The user may also ask the LLM for additional variation, input, other information, etc. before making the final determination.

Generally, the solutions may include user-generated brainstorming solutions, LLM-generated brainstorming solutions, a combination of user and LLM generated brainstorming solutions, databases of information with ideas containing like characteristics (such as the LLM analysis of the patent database, textbooks, historical company technological capability databases, etc.), etc. After the dimensional constraints and the solutions are determined, the solutions may be ranked and prioritized further, and a landscape of fitness may then be determined.

The landscape of fitness may be down-selected to prioritize the most attractive solution using the boundary conditions and constraints, which may be set to what the most attractive (or best) solution should achieve based on the objective and market criteria, etc. The solution embodiment and category are then selected, and the solution is then provided to the solution implementation phase, which evaluates the solution in the context of the unmet need or opportunity. The evaluation in the solution implementation phase facilitates the refinement of the solution and commercialization of the solution to solve the unmet need or opportunity (also known as the opportunity of need).

The solution generation phase may also be know as the solution specific phase.

### Solution Implementation Phase

In certain embodiments, the solution implementation phase refines the opportunity area and the solution through LLM interactions, explores IP, regulatory, and legal regimes through LLM interactions, generates a “get to market” plan based on the solution, and optimizes the plan through LLM interactions.

In certain embodiments, the solution implementation phase further refines the opportunity area that was defined in the solution agnostic phase, as well as the solution to solve the opportunity of need that was defined in the solution generation phase.

For example, the solution may be refined to understand what IP criteria or opportunities may be available. The LLM may direct questions to the user to better define the unique aspects of the solution (the idea), the need area, and other criteria, which may be used in combination with a review of the relevant IP information to make recommendations for the best intellectual property strategy.

In another example, the solution may be refined to understand the regulatory and legal criteria that may be applicable. The LLM may direct questions to the user to better define certain aspects of the solution, the need area, and other criteria, which may be used in combination with a review of the relevant regulatory and legal information to make recommendations for the best regulatory strategy and legal approach (which may differ by industry). For example, the solution implementation phase may suggest a medical product classification by the FDA in accordance with FDA guidance and the description of the solution, which may be further developed into a test plan and medical documentation required for submission to the FDA.

Various documents may be pre-populated as context for the IP, regulatory and legal criteria, such as business plans, patents, regulatory documentation and submissions, quality control system information, manufacturing SOPs, regulatory opinions, communications, warning letters, other information which may identify activities that need to be achieved, risks and uncertainties to manage, etc. These documents may be historical documents provided by the user, as well as LLM-generated documents.

The LLM may suggest a plan or staged development activity approach for the solution to “get to market” that may include testing, validation, manufacturing, regulatory submission, marketing, as well as other areas or steps that may be recommended by the LLM or curated by the user based on a desired process for this solution approach. Risks and uncertainties may be flagged by the LLM (as well as the user) in order to facilitate a stepwise understanding of which steps may be conducted first in order to minimize undesirable variables, such as the duration of development (timeline), regulatory risk, uncertainties, financial investment at risk, etc.

The LLM (as well as the user) may then suggest a work plan that provides concrete actions and steps as output, such as a Gantt chart, a PERT chart, a work breakdown structure (WBS), a Kanban board, a Scrum board, a milestone chart, a timeline, a project network diagram, a rolled-up project planner, a cross-functional flowchart, a project checklist, a process flow diagram, etc. Step-by-step instructions for what activities may be conducted to provide for the most efficient and effective path considering the unknowns and risks to the project, along with investment, timeline, and other factors, may also be provided.

### System Software Architecture

As discussed above, the system is configured to implement the strategic innovation process 100 by executing system software. In certain embodiments, the system software may include a main application that executes a sequence of modules, and each phase of the strategic innovation process 100 may be implemented by one or more modules. The sequence may be determined based on prompts provided by the user (as well as the system). A quality score may be generated after the completion of each module, and a determination to proceed to the next module in the sequence may be performed based on the quality score.

If the system is executed as a continuous or semi-continuous process, an input and output cadence within the sequence of modules may be performed. These modules may be arranged by a user (or the system) automatically or semi-automatically based on the specific prompt or question posed by the user or the system. At the completion of each module, a quality score may be determined. The system may execute the one or more modules within each phase until information is determined to be missing, or until the quality of the information is not sufficient to pass the threshold values. If the threshold is not met, then additional queries may be levied, or additional processes may be performed.

For example, the users that are queried may be identified by a user profile or other user identifying metrics or information that associate the users with the missing information. The user profile may be based on a user's LinkedIn profile, a PubMed profile, patent filings, office action responses from regulatory and or patent interactions, clinical trials. gov information, employee directory and or company employee biographical files, corporate website, government website, etc.

In another example, relevant regulatory databases may be searched to find the missing regulatory information. Alternatively, specific users may be identified that have regulatory experience, such as an FDA consultant, a regulatory affairs employee, etc., and then queried for the missing regulatory information.

In a further example, patent information may be missing. Specific users may be identified that have relevant experience with respect to patent validity, patent infringement, freedom to operate, risk of enforcement, etc., as well as to provide additional IP-related information.

In a further example, a specific user may be identified as one of a variety of market stakeholders, such as users of a prospective product, a person or group with the need being researched, a decision maker for the value of a solution to solve a need, a payer or a procurement group that is transacting or is likely to transact, etc. Stakeholder input may be solicited from these external stakeholders in order to define the constraints of the need in certain relative terms, such as “must have,” “nice to have,” etc. These constraints would then form the foundation of the product requirements in the solution generation phase, in which the constraints are turned into requirements that are specific to a particular technology.

In a further example, the system may reach out to identified users to solicit input on topics that are related to internal company stakeholder feedback, etc. Example topics may include meeting the requirements of the company stakeholders internally regarding financial metrics for business performance, alignment with manufacturing assets, marketing synergy, sales channel alignment, etc. In other words, these users may be internal stakeholders on which the alignment determinations are performed during the alignment phase.

In a further example, the system may reach out to identified users to solicit input on topics that are related to any number of issues, such as consultants, payment for medical reimbursements, etc.

The system may reach out to the identified users by generating and sending an email, a text message, a chat message, etc., to the users that includes a list of questions, and then analyzing the subsequent responses to find the missing information. Additionally, the system may reach out to the identified users through audible or voice interactions using text-to-speech and speech-to-text conversions, such as initiating a call to an identified user, and then engaging the identified user in an interactive interview that includes questions and responses, etc.

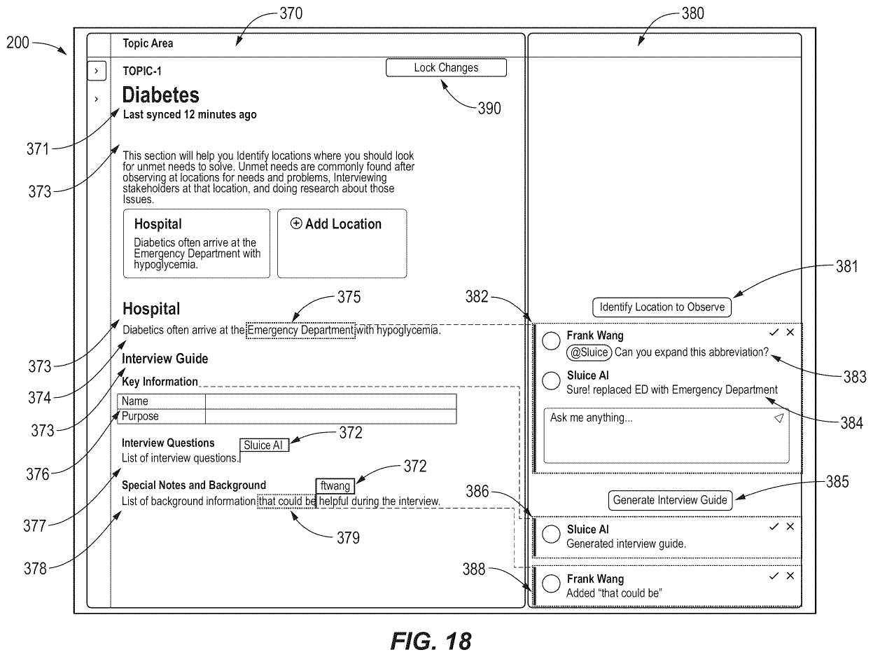

In certain embodiments, the list of questions may be administered to the user by a chatbot application that is associated with the module. Rather than sending the list of questions directly to an identified user, the system generates and sends an access link to the chatbot application via an email, a text message, a chat message, etc. After the identified user accesses the chatbot application using the access link, the chatbot application then interviews the user for the information needed to answer the list of questions. In some modules, the list of questions may have been generated by another chatbot application and supporting LLM, as the list 377 of interview questions that may be created or generated by the LLM depicted in FIG. 18.

Advantageously, the “interview” chatbot application may be used in many different phases of the strategic innovation process 100, such as interviewing to identify needs, interviewing to identify stakeholder criteria or constraints, interviewing to get feedback on concepts, interviewing to get feedback on prioritization of features needs or concepts, etc. Generally, the interview chatbot application is a feedback solicitation tool that may solicit input from users that may be critical to the generation of certain elements of a module, to solicit feedback from users that may be used to validate those elements and ensure that they are correct and in-line with the voice of the market, etc.

The user may intervene at any time during the execution of the modules. For example, the user may intervene when a module or a phase may not be completed because information is missing or the information is otherwise insufficient. After the user provides the missing information, or supplements the insufficient information, the module or the phase may then complete, the process may continue.

In certain embodiments, the process may incorporate pauses (or breaks) so that the user may review the intermediate results, provide input, provide guidance, etc., and determine whether to proceed to the next step of the module or the next phase. The pauses may be unrelated to the completeness or sufficiency of the information, so that the user may intervene even when the module or phase would otherwise complete.

Various methods may be used to determine whether sufficient information is present to proceed, such as the statistical methods of range, standard deviation, skewness, kurtosis, normality test, outlier detection, correlation analysis, regression analysis, monte-carlo simulation, hypothesis testing, cross-validation, anomaly detection, data provenance, ensemble learning, fact-checking, rule-based systems, human-in-the-loop systems, etc.

### User Interface, Wikis and Workflows

In certain embodiments, the user interface 200 may present information to the user in an interactive series of dashboards, wiki interfaces (or simply “wikis”), document frameworks, etc., so that the user may add, review, and curate the information. The user interface 200 may present a topic region that is supported by one or more LLMs, either directly (such as topic region 240, etc.) or via a chatbot application (such as topic region 250 and chatbot region 260, etc.). Some topic regions may include pre-loaded or user-inputted information, and may not need LLM support.

These wikis may include one or more sections that are identified by one or more headers and subheaders. The headers and subheaders may describe a topic area, a category area, a problem, a need, a need statement, an issue, etc. For example, the topic region 250 (see FIG. 4B) may present a wiki that includes a header 251 (“Treatment”) and subheaders 253 (“Need Statements”, “Problem,” “Incidence/Prevalence,” etc.). In another example, a solution agnostic module may present a wiki with subheaders describing one or more solution agnostic issues, solution agnostic pain points, etc. Similarly, a solution generation module may present a wiki with one or more headers and subheaders describing one or more technologies, technical approaches, mechanisms of action, concepts, embodiments, solutions to an unmet need, a combination of an agnostic solution and a specific solution, etc. In some embodiments, a wiki may include a section with a header but no subheaders, or a section with no headers and subheaders.

Examples of wiki headers and subheaders include, inter alia, Introduction, History, Overview, Description, Definition, Etymology, Need, Need Statement, Problem, Epidemiology, Incidence, Prevalence, Pathophysiology, Usage, Development, Technology, Applications, Impact, Criticism, Battle Readiness, Critical Threats, Weaknesses, Opportunities, See also, References, Early history, Modern history, Types, Subtypes, Characteristics, Components, Parts, Functions, Principles, Operation, Applications, Impact, Benefits, Drawbacks, Challenges, Limitations, Future directions, Related topics, Specific examples, Case studies, Comparisons, Contrasts, Lists, Tables, Diagrams, Patents, Intellectual Property, Regulatory, Competitors, Competition, Business Models, Illustrations, Infographics, Videos, Audio files, External links, Internal Links, Sub-subtopics, Additional details, Design, Design Plan, Testing Plan, Regulatory Plan, FDA, CMS, EU, CFDA, International Differences, Commercialization Plan, Nuances, Exceptions, Special cases, Controversies, Highly specialized topics, Technical details, In-depth analysis, Research findings, Expert opinions, Ongoing developments, Debates, Different perspectives, Related Wikis, Related Needs, Linked Insights, Insights, etc.

A wiki may include one or more hidden fields. Each hidden field may be linked to a context or prompt that is associated with a header. In response to the selection of the prompt by a user, an LLM supporting the wiki may automate the creation of subheaders and associated sections for that header through interaction with the user, such as by presenting a list of questions, a list of topics of interest, etc. Additionally, an LLM supporting the wiki may automate the creation of information for each section. The specificity of these prompts may further define how an LLM may respond in each section. A prompt may also be associated with a subheader, which may be linked to a chat interface or application for the associated section. For example, FIG. 4B depicts a prompt 255, associated with a subheader 253 (“Incidence/Prevalence”), that may be linked to a chat interface for an LLM, such as chatbot region 260.

In one example, in response to a user selecting an FDA strategy prompt under a wiki header (or subheader) for a breast pump, a chatbot application (which may also be known as a copilot chatbot) may be pre-loaded with the FDA guidance documentation, as well as other information. The FDA-specific prompt criteria enables the chatbot application to interact with the user as an expert in regulatory information on breast pumps, and guide the creation of the documentation in this section of the wiki based on one or more criteria required to complete the section. The system may automate the process of creating this regulatory section with (or without) guidance from the user, with input from the other sections of the wiki as context from the same family and chain of unmet need, with the solution agnostic boundary conditions, and with any other relevant information that has been linked to this wiki. The wiki may be a solution agnostic wiki for an area of opportunity (such as the breast pump), a solution specific wiki that is relevant for that opportunity area (such as the breast pump), etc. Advantageously, the system and the users may interact with one another to complete the relevant documentation and questions in a focused way on this topic area of interest. In some embodiments, the topics, headers, etc., may be pre-loaded, and the user may select a header of interest from a drop-down list, input a name into a field, etc.

In one example, “FDA Strategy” may be pre-loaded as a trigger for a header or subheader. When the user types “Regulatory Strategy” into the prompt field, the system may ask the user if this input is the same as “FDA Strategy.” If the user agrees, then “Regulatory Strategy” may be linked to this “FDA Strategy” prompt, and the user may adjust the name to match “FDA Strategy.” Alternatively, the linkage between “Regulatory Strategy” and “FDA Strategy” may be automatically determined by the LLM, embeddings, or other strategies or algorithms. This section of the wiki now enables the user to communicate with an LLM that is tuned to, or contains a pre-loaded prompt that is specific to, “FDA Strategy.” When the user moves to a new section of the wiki, such as “Market Analysis,” etc., a similar interaction may be provided for the new section, and so on for any additional sections.

The system may also support user-defined headers and subheaders for one or more wikis. The user may pre-load prompts, instructions, context information, etc., for a user-defined header or subheader that may be accessed when another wiki includes the same user-defined header or subheader. Advantageously, users may create their own custom LLM chat interactions to support the documentation and completion of the sections of wiki that may not be included in the system. These prompts and relevant documentation may be stored in a local or network database. The system software modules may also include application programming interfaces (APIs) that access and integrate other systems and data, and the user may access these systems and data to share information.

A description of the wiki's intent, purpose or objective, the headers and subheaders, and the sections may be listed. The description may provide a pre-loaded context, and the description may be searched and then inputted or selected by a user or an LLM. For example, to add a new section, the user may input a header (or subheader) of “Intellectual Property.” The LLM may then ask the user to select one of several different categories that include pre-loaded LLM models or LLM prompts, such as “Non-Patent Prior Art Analysis,” “Claims Generation,” “Detailed Description of the Invention,” “Figures and Drawings,” “Company Competitive Patent Landscape,” “Patent Prior Art—[by country]”, etc. In response to the selection of one of these categories, the LLM may generate outputs that are consistent with the desired category of the wiki. For example, for the “Patent Prior Art—[USA]” category, the system may curate a list of intellectual property that is analogous to the prior art that would be expected for the ideas and or need areas articulated within the rest of the wiki.

These interactions may prompt an automated LLM to immediately populate the section. Alternatively, these interactions may be chat-based interactions with an LLM that curates the creation of content in that section based on the query responses from the user, other information input by the user, information supplied by the LLM, supplementary database or dataset. For example, the process 600 identifies or creates need statements from literature or interview guide questions, and may leverage interactions with an LLM. In other examples, the processes depicted in FIGS. 5, 6, 11, 12, 13, 15, 16, 17 may also leverage interactions with an LLM.

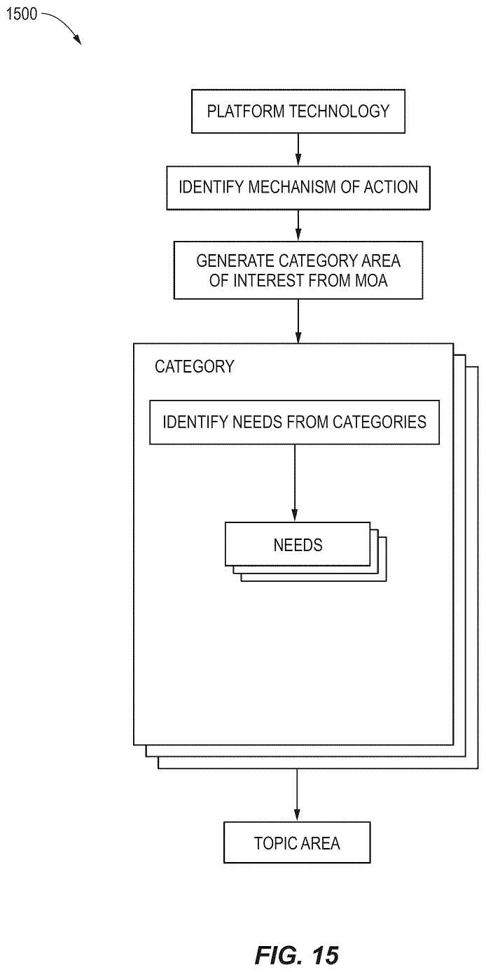

FIG. 15 depicts a process 1500 for determining a topic area, in accordance with embodiments of the present invention.

In certain embodiments, a platform technology is selected, the solution agnostic mechanism of action and it's constraints are identified, and the category areas of interest are generated from the mechanism of action. For each category, the need statements are identified, and the topic area is determined based on the need statements of each category. The topic area matches the platform technology.

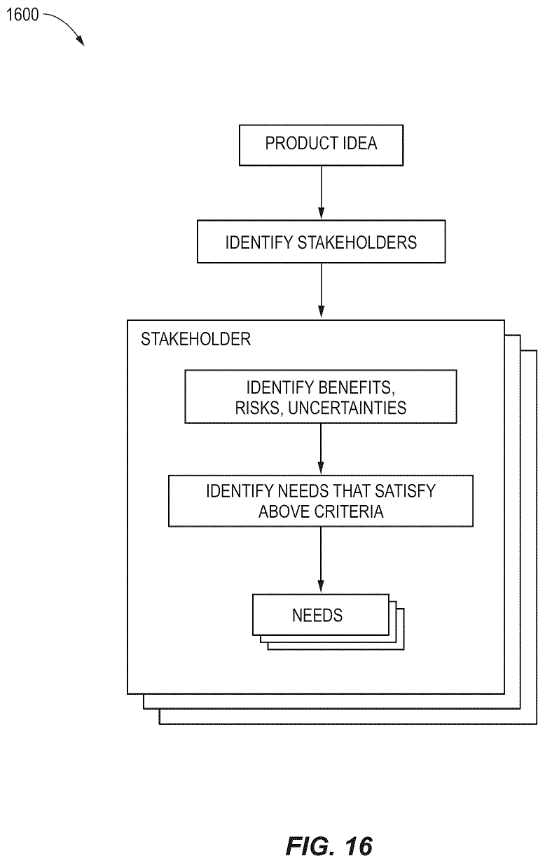

FIG. 16 depicts a process 1600 for determining need statements, in accordance with embodiments of the present invention.

In certain embodiments, a product idea is selected, and the stakeholders are identified. For each stakeholder, the benefits, risk, and uncertainties are identified, and the need statements that satisfy the criteria are identified. The need statements match the product idea.

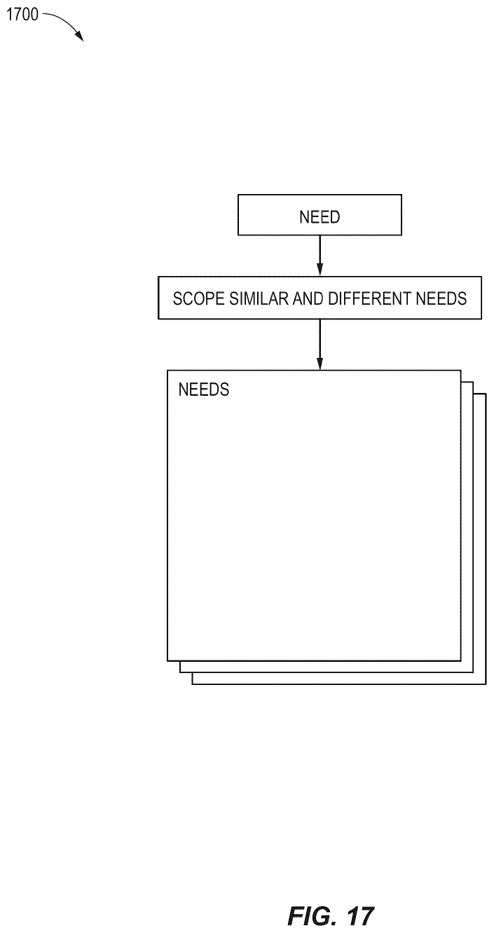

FIG. 17 depicts a process 1700 for refining a need statement, in accordance with embodiments of the present invention.

In certain embodiments, a need statement is selected, and then similar and different need statements are scoped and adjusted to identify and create new need statements from the original need statement.

In certain embodiments, the user may complete a series of sections based on a format provided by the system, a format curated by a user, a format created by an LLM, etc. For example, the LLM-created format may result from guided interactions with a user. The LLM may initially create information based on data that are available to the LLM. The confidence threshold for the information is determined, and the LLM continues to create information as long as the confidence level is satisfied (or passed). When the information no longer satisfies (or passes) the confidence threshold, the LLM may ask the user for input to complete the format.

Similar models may be used for other categories, such as Regulatory Strategy (FDA, FTC, FCC, and or otherwise), Payment Strategies (Centers for Medicare and Medicaid/Insurance Companies/Commercial Payment and Ecommerce Databases), Technology (Database of technologies from technology databases), Services (types of information where the act is conducted by an individual or software), Market Analysis (such as market sizing information of an opportunity), and so on.

In certain embodiments, the system software may include the user interface 200, and the backend architecture of the system may use a routing technique, a database selection technique, an LLM, etc., to pre-sort which model to use based on the question and inquiry addressed. This may be done separately or in combination with the use of any section-specific or user-specific information describing the kind of topic that is desired to be addressed.

For example, LangChain is a framework designed to simplify the creation of applications using LLMs. LangChain may include prompt templates, LLM wrappers, indexes, chains, agents, etc. LangChain, or a similar context aware system or architecture, may be used in combination with the previously mentioned techniques to facilitate chat interactions about topics of interest. Additionally, LangChain may generate content for topic sections of interest, and summarize external content, wiki content, alternative internal content, etc., so that ideas may be readily communicated and understood for other stakeholders. This communication may also be curated and customized for the stakeholder audience of interest, such as a more scientific explanation of the technology to an R&D leader asking about the project, a more business ROI focused explanation of the project to a marketing or sales leader asking about the project, etc.

In certain embodiments, wiki section data may be automatically created by the system in response to user interactions, code, prompts, LLM self-prompting, LLM prompting another LLM within the system, etc. The data may be identified as LLM-created data or user-created data. For example, FIG. 9 depicts LLM-created data 316 and user-created data 318. After the data has been entered into the system, changes to the data may be tracked and a version control technique may be applied to the data. The user may then review the changes that were made to the data, and accept or revert each change individually or select a particular version of the data. Additionally, the user may also manually edit the data.

FIG. 18 depicts another view of the user interface 200, in accordance with embodiments of the present invention.

In certain embodiments, the user interface 200 may include the navigation index region 210 (not depicted), a topic region 370, and a chatbot region 380. In this view of the user interface 200, the topic region 370 may be directed to diabetes. The topic region 370 may include a header 371 (such as “Diabetes”) and subheaders 373 (such as “Where to Observe,” “Hospital,” etc.). The chatbot region 380 may include, inter alia, chat interactions 382 between a chatbot application and the user (also known as chat bubbles), input 383 from the user (such as responses, questions, instructions, etc.), output 384 from the chatbot application (such as questions, responses, etc.), etc. The chatbot region 380 may also include a widget 381 (such as “Identify Location to Observe”), a widget 385 (such as “Generate Interview Guide”), status information 386, status information 388, a lock widget 390 (such as “Lock Changes”), etc. The chatbot application may include, or be coupled to, an LLM that is configured to generate information for the topic region 370 based on interactions with the user in the chatbot region 360.

With respect to the topic region 370, the “Where to Observe” subheader 373 denotes a section that includes a general description, and one or more locations at which unmet needs or problems to solve may be observed (such as a hospital, doctor's office, clinic, etc.). The information for each location may include the name of the location, a description of the unmet need, etc., and may be generated in response to the selection of an “Add Location” widget displayed in the topic region 370, a chat interaction in the chatbot region 380 that occurs in response to the selection of the widget 381, etc. In this example, a “Hospital” location has been identified, and the name of the location and the description of the unmet need have been generated and displayed. Additionally, in response to the identification of the “Hospital” location, the subheader 373 (“Hospital”) and a description 374 of the “Hospital” section may be generated and displayed, and the widget 385 (“Generate Interview Guide”) may be displayed. In this example, the description 374 explains why a hospital is a location at which needs and problems may be found relating to the topic of diabetes.

In response to the selection of the widget 385 by the user, the subheader 373 (“Interview Guide”), and other information, such as key information, interview questions, special notes and background information, etc., may be generated and displayed. The key information may include a table 376 listing the name of each stakeholder and the purpose of each interview. Interview questions may include a list 377 of interview questions. The special notes and background information may include a list 378 of background information helpful during the interview. The questions in the list 377 of interview questions may be displayed to the user in response to selecting the list 377. Similarly, the data in the list 378 of background information may be displayed to the user in response to selecting the list 378.

Advantageously, the data in the “Hospital” section may be created by the system in response to user interactions, code, prompts, LLM self-prompting, LLM prompting another LLM within the system, etc. The data may be identified as LLM-created data or user-created data.

For example, the original description 374 for the “Hospital” subheader 373 may have been “Diabetics often arrive at the ED with hypoglycemia.” To change the original description 374, the user may provide a question or instruction as input 383 to the chatbot application, such as “Can you expand this abbreviation?” In response, the chatbot application may query the LLM, provide the LLM's response as output 384 (such as “Sure! Replaced ED with Emergency Department”), and change the original description 374 to “Diabetics often arrive at the Emergency Department with hypoglycemia.” The phrase 375 (“Emergency Department”) may also be highlighted in the description 374 to indicate that phase 375 was created by an interaction between the user and the LLM in the chatbot region 380. The highlighting may include a region that surrounds the phase 375 with a different fill or background color, a different font color for the phase 375, a different font type for the phase 375, etc.

In another example, the list 377 of interview questions may be created or generated by the LLM based on the description 374, the table 376 of key information, as well as other information relating to the “Hospital” location that the LLM may access. The icon 372 may indicate that the list 377 is LLM-generated (such as a flag labeled “Sluice AI”). Additionally, the list 377 of interview questions may be re-generated in response to the selection of the widget 385, in response to an instruction provided as input 383 to the chatbot application by the user, etc.

In another example, the list 378 of background information may be created or generated by the LLM based on the description 374, the table 376 of key information, the list 377 of interview questions, as well as other information relating to the “Hospital” location that the LLM may access. The original description of the list 378 may have been “List of background information helpful during the interview.” To change the original description of the list 378, the user may edit the original description of the list 378 in topic region 370 to add the phrase 379 “that could be.” In response, the chatbot application may provide status information 388 as output to indicate that the user provided the phrase 379 (“Added ‘that could be’”). Additionally, the phrase 379 (“that could be”) may also be highlighted in the list 378 of background information to indicate that phrase 379 was created by the user. The highlighting may include a region that surrounds the phrase 379 with a different fill or background color, a different font color for the phrase 379, a different font type for the phrase 379, etc. The icon 372 may indicate that a portion of the list 378 of background information is user-created (such as a flag labeled “FWang”). Additionally, the list 378 of background information may be re-generated in response to the selection of the widget 385, in response to an instruction provided as input 383 to the chatbot application by the user, etc.

Advantageously, the data that are input or changed by the users (user-created data) and the data that are generated or changed by the LLMs (LLM-created data) may be identified and tracked over time.

In certain embodiments, the system may pre-load the prior wiki data entry from the user or LLM as context for the next interaction in order to facilitate the version updating with context from prior versions of that wiki section. This process may be controlled by one or more user preference settings. The user may also select a component of the system software, such as a section in a wiki, an entire wiki, the entire system, etc., and then select a widget that may be presented in the user interface 200, such as the lock widget 390, etc., to alert the system that no further adjustments or changes based on additional chat interactions are desired to be incorporated.

This component is then fixed or locked to prevent other users, LLMs, etc., from editing or adjusting the locked component until the owner, a user with proper privileges, etc., unlocks the component. Similarly, the lock may be performed on a particular segment of text within a section of a wiki (such as phrase 375 depicted in FIG. 18) to prevent changes by other users, LLMs, etc. The lock may be overridden or removed by the owner, a user with administrator privileges, a hierarchy of users within the system, etc. Another user without override access may notify the owner of the lock that access is requested to the segment of text, wiki section, wiki, etc., by clicking a notification icon. The owner of the lock may then override or remove the lock.

In certain embodiments, a user may interact with a chatbot application and the associated LLM in a chatbot region of the user interface 200 without changing the content of the wiki. For example, the user interface 200 may include a widget (such as a button, switch, toggle, check box, etc.) that is selectable by the user to permit or prevent changes to the topic area of the wiki during or after the chat interaction. Advantageously, changes to the topic area of the wiki may be prevented in order to allow the user to interact with the LLM to gain additional understanding about the topic area, to solicit more questions from the LLM to develop appropriate context prior to generating in the desired text in the wiki section, etc. Additionally, the permitting or preventing changes may be configured to apply to a single LLM for one section of the wiki, all the LLMs in the wiki, all the LLMs in the system, etc.

The system may be configured in several ways to protect the data. For example, the data may be exclusively edited by a single user (or LLM), the data may be simultaneously edited by multiple users (and LLMs) without restrictions, the data may simultaneously edited by multiple users (and LLMs) but each user may lock the data to prevent changes by the other users (and LLMs), etc. As described above, editing the data may be done at the section level of a wiki, at the wiki level, at the system level, etc. For example, multiple users may simultaneously edit the data within a section of a wiki without restrictions. When one user makes a change to the data in his user interface 200, the change may be attributed to that user and displayed in the user interface 200 provided to the other users. The changes may be stored in the system memory with user attributions and timestamps, so that a history and audit record of the interactions may be preserved.

In certain embodiments, the system may support collaborative editing between users, as well as collaborative editing between users and LLMs (or other AI systems). During collaborative editing, the system may track certain information related to the changes that the users and the LLMs make to the data, such as what text was changed or suggested, at what position in the phrase, sentence, paragraphs, etc., the change was made or suggested, etc. The changed made to a particular section of a wiki by each user and LLM may be identified and displayed in the user interface 200. Advantageously, multiple users and LLMs may simultaneously edit the document.

In certain embodiments, the system may use Conflict-Free Replicated Data Types (CRDTs) to support collaborative editing. A CRDT is a data structure that may be replicated across multiple computers in a network. CRDTs ensure that changes made by one user are visible to the other users and the LLMs. Generally, CRDTs provide distributed systems strong eventual consistency without the need to synchronize through a central server or resolve conflicts through complex algorithms. CRDTs are particularly useful in scenarios where network partitions may temporarily isolate certain nodes of the network, or when the system must continue to operate in a decentralized manner with high availability, such as for applications that support collaborative editing, distributed databases, etc.

CRDTs may be classified into two main categories based on their approach to integrating concurrent updates, state-based CRDTs (or CvRDTs) and operation-based CRDTs (or CmRDTs).

For state-based CRDTs, each node in the system maintains a state that is periodically synchronized with other nodes. The states are merged using a mathematical operation that ensures idempotence (if an operation is repeated once or more than once, the same result is achieved), commutativity, and associativity, which means that the order of merge operations does not affect the final state. This property guarantees convergence to the same state across all nodes, assuming all updates are eventually delivered.

For operation-based CRDTs, instead of sharing and merging states, nodes transmit operations that need to be applied to other nodes' states. These operations are designed to be commutative, meaning they can be applied in any order and still produce the same final state. For this to work reliably, the system ensures that all operations are delivered at least once and often requires a reliable broadcast mechanism to prevent operations from being lost.

Advantageously, the system may display changes as annotations that the users may approve (or reject) as an addition or a modification to the section of the wiki, such as the modification 278 that is displayed as underlined text in FIG. 7 (“This suggests that the patient is still in pain. I wonder if this patient is a criminal.”).

In certain embodiments, the system may provide enable users to suggest, preview, review and approve, etc., changes to the data without committing (storing) the change in memory. The user interface 200 may display a preview of the change to the data of a section of a wiki, and then ask the user to accept or reject the change before the change is stored in memory. Once stored in memory, the change to the data may be visible to the other users of the system. For example, the preview may be a difference between the existing text a proposed change to existing text, the preview may simply replace the existing text with the proposed change to the existing text, etc. The proposed change may be highlighted as well. The user interface 200 may include a selectable widget that enables and disables this functionality, such as a button, switch, toggle, check box, etc. Additionally, the users may selectively accept certain changes to the data, reject other changes to the data, and edit the proposed changes. In certain embodiments, each user's proposed changes may be visible to the other users, and each user may selectively accept certain changes to the data, reject other changes to the data, and edit the proposed changes of the other users. Advantageously, the users may come to agreement with respect to the proposed changes before commitment to memory and incorporation into the work product.

In certain embodiments, LLMs that support different wikis, as well as the filtering, ranking and prioritization functionality of the system, may be trained based on specific individual, departmental, and expertise data. For example, one LLM may be trained to predict how an investor may respond to a particular topic area, another LLM may be trained to predict how a university faculty may respond to the particular topic area, etc. Similarly, LLMs may be trained to predict responses from the FDA, responses from prospective companies looking to acquire or license the idea, etc. These responses may be requested by, and presented to, the users during the different phases of the strategic innovation process 100. Advantageously, a user may solicit this “pre-feedback” from specifically-trained LLMs to provide guidance at key points within the strategic innovation process 100, such as when users are taking decisions on opportunity, need selection, idea selection, solution selection, etc.

The curation of the proper training data allows the LLM to be trained to predict the responses of an individual, the responses of a person with a specific role in an organization, the responses of an agency, etc. In other words, the LLM does not need to be trained as a generic model, instead, the LLM may be trained to respond from different perspectives, such as an individual (such as Dr. Smith at the FDA, etc.), a job role (such as an FDA regulatory reviewer, etc.), an agency (such as the FDA, etc.), etc. Public data, such as reviews of competitor products, etc., as well as private data, such as prior communications with the reviewer or agency, etc., may be used to develop the training data for the LLM.

In certain embodiments, one or more documentation modules may assist the user during the strategic innovation process 100, such as when a section of a wiki, a wiki, a phase, etc., is completed. The documentation modules advantageously generate various documents, such as target product profile documents, quality and regulatory submissions, grant submissions, etc.

For example, a grant documentation module may generate a grant submission based on an opportunity of need that was identified and processed in the solution agnostic phase 130 and the solution generation phase 140. More particularly, the grant documentation module may access the data that were created by the wikis in the solution agnostic phase 130 and the solution generation phase 140, such as idea and need pair data, opportunity of need data, chat interactions, etc., and then generate the grant submission based on these data. Additionally, grant guidelines, prior grant submissions, prior grant submission feedback, etc., may be also pre-loaded into the system to provide additional data for the generation of the grant submission. In certain embodiments, the generation of the grant submission may be performed under user review.

Additionally, published grant solicitations, funding solicitations, etc. may be pre-loaded into the system using various mechanisms, such as Web crawlers, RSS feeds, APIs, webhooks, long polling, push notifications, manual input by a user, etc. Similar methodologies and techniques may be used to update the system with respect to other types of information, such as patent information, changes in organizational preferences, changes in regulatory guidance, etc., from a number of organizations and agencies, such as the FDA, Department of State, Department of Defense (DOD), Department of Justice (DOJ), Department of the Interior (DOI), Department of Agriculture (USDA), Department of Commerce (DOC), Department of Labor (DOL), Department of Health and Human Services (HHS), Department of Housing and Urban Development (HUD), Department of Transportation (DoT), Department of Energy (DOE), Department of Education (ED), Department of Veterans Affairs (VA), Department of Homeland Security (DHS), National Aeronautics and Space Administration (NASA), Environmental Protection Agency (EPA), FDA, National Security Agency (NSA), Central Intelligence Agency (CIA), Federal Bureau of Investigation (FBI), Drug Enforcement Administration (DEA), Bureau of Alcohol, Tobacco, Firearms and Explosives (BATFE), Securities and Exchange Commission (SEC), Federal Trade Commission (FTC), Federal Communications Commission (FCC), Consumer Product Safety Commission (CPSC), United States Postal Service (USPS), Amtrak, Federal Reserve System, World Bank, International Monetary Fund (IMF), sub-organizations of the above organizations (such as the Air Force, Navy, Army, etc.), etc.

After an area of need or opportunity is identified in the solution agnostic phase, a newsfeed may be enabled to automatically populate information about that area of need or opportunity from public source as well as non-public sources (such as a company intranet, etc.). Similarly, once a solution is identified in the solution generation phase, another newsfeed may be enabled to automatically populate information about that area of need or opportunity from public or non-public sources. Generally, newsfeeds may be used by other phases of the strategic innovation process 100, as well as other portions of the system.

Populating a newsfeed may be done using a variety of methods, such as searching for available data, integrating data received from external sources, etc. These data may include relevant patent publications, relevant FDA approvals issued, relevant news stories, relevant regulatory or legal changes or guidance issuances, changes in market reports, census publications, investment solicitations, corporate shareholder meetings, etc. These newsfeed items and other data may be used in conjunction with information input by the users or created by the LLMs to prioritize the selection of an area of need or opportunity and the selection of a solution based on a variety of fitness factors.

As discussed above, the attractiveness of a need or opportunity and a corresponding solution (or solution idea) may be evaluated based on a variety of factors, such as severity of the problem, patient impact, understanding of the mechanism of action of the problem, incidence, prevalence, economic value created by solving the problem, value proposition, market attractiveness, competitive differentiation, competitive position, durability of defensive position, cost of goods, margin, company infrastructure fit, desirability, ease of demonstrating proof, ability to make an impact, technical feasibility, urgency, time to market, net present value, alignment with my values. and or a variety of other factors. These factors may be weighted by the LLM and the user, and the weighting may be based on input from a variety of external data sources (such as newsfeeds that may reflect real-time or near real-time information, etc.), as well as additional users (such as the company executive team, etc.).

Additionally, the system may include specific user login and identity verification. An audit record, blockchain, or other type of data verification technique may be used to identify and verify which user entered which data, which may be useful to attribute ideas for authorship of intellectual property. Generally, throughout many aspects of the strategic innovation process 100, different tasks may be assigned to different users. When a task is assigned by a user to another user, from an LLM supporting a wiki to a user, from the system to a user, etc., then an icon may appear on the user profile and a notification may be sent to the user that there is a task waiting that needs their input. The task notification feature may be turned on and off, and the task notifications may be differentiated into distinct levels, such as light, moderate and heavy, or other nomenclature, to differentiate the tasks into different levels of urgency or importance. Similarly, the notification may identify whether a task was assigned by a user, an LLM supporting a wiki, the system, etc. Users and the administrators may control the timing and frequency of the notifications in accordance with user preference settings, task prioritizations, etc.

As discussed above, the user may specify the headers and subheaders in a wiki based on the task or objective of the wiki. For example, if a user wants to write a patent application, one subheader may refer to inventorship, one subheader to the title, one subheader to the background section, one to the brief summary of the figures, one to the detailed description of the invention, one to the claims, and one to the abstract. A subheader referring to the drawings may also be included. Each of these subheaders may refer to a specific chatbot application with a supporting LLM (or similar AI based system) that may be pre-loaded with a specific prompt that may guide the user in the creation of the specific section of text or other output required by that section. For example, in the inventorship section, the LLM may be pre-loaded with a prompt that requests specific information about each inventor (such as full name, mailing address, etc.), a description of each inventor's contribution to the invention, etc. Additionally, the LLM may be pre-loaded with a prompt that asks about the overarching theme of the invention in order to create an appropriate title.

In certain embodiments, each section of a wiki may include a different chat interaction for which the supporting LLM may be trained to request certain information from the user before providing an output that is specific to that section. In these chat interactions, the LLM may search public information, such as a patent database, innovator-referenced material, expected data sets, the internet, etc. to provide the most accurate information and best outputs. The LLM may also search non-public information, such as unpublished patent applications stored on a company intranet, etc., to provide the most accurate information and best outputs. Additional documents of a variety of types may be created with a similar header and subheader structure.

Similarly, presentations, video, scripts, and other forms of media may be created in a similar, stepwise, section-by-section manner, such as standardized test protocols, safety data sheets, medical imaging scans, engineering blueprints, geological survey reports, financial disclosure statements, internal audit reports, quality assurance checklists, software installation manuals, training modules, incident reports, environmental impact assessments, meeting minutes, product specifications, marketing brochures, employment contracts, non-disclosure agreements (NDAs), purchase orders, invoices, legal briefs, court transcripts, legislative bills, research grant proposals, data analysis tables, scientific journal articles, technical whitepapers, user guides, instructional videos, audio recordings of interviews, emergency response procedures, product recall notices, social media content moderation guidelines, code of ethics documents, accessibility compliance reports, industry best practice manuals, patent applications, compliance certification documents, project management plans, risk assessment reports, customer feedback surveys, network security policies, system architecture diagrams, change management records, HR policy manuals, supply chain audit reports, investment prospectuses, clinical trial protocols, patient consent forms, manufacturing process descriptions, competitor analysis reports, market research summaries, technology assessment documents, regulatory submission packets, pharmaceutical formulation records, intellectual property agreements, software development documentation, operational manuals, service level agreements (SLAs), corporate governance policies, shareholder meeting reports, sales forecasts, product development timelines, employee training records, tax compliance filings, export/import documentation, logistics planning documents, inventory management systems descriptions, corporate sustainability reports, data privacy impact assessments, cybersecurity incident response plans, vendor management agreements, client project briefs, performance benchmarking reports, financial modeling spreadsheets, digital marketing strategies, content management policies, mobile app development guides, quality control test results, architectural design specifications, energy consumption audits, agricultural research findings, automotive testing protocols, telecommunication network layouts, facility maintenance logs, educational curriculum guides, health and safety training videos, intellectual property catalogues, customer relationship management strategies, e-commerce analytics reports, supply chain resilience assessments, crisis management plans, investment due diligence checklists, real estate appraisal documents, advertising campaign analyses, software license agreements, employee onboarding checklists, privacy policy updates, cloud computing architecture schematics, waste management procedures, renewable energy project proposals, biotechnology research papers, aerospace engineering test results, maritime navigation charts, public relations press releases, event planning itineraries, retail merchandising plans, hospitality service standards, construction project bids, forensic audit findings, digital asset management guidelines, labor market analyses, cultural heritage preservation plans, international trade compliance manuals, artificial intelligence training datasets, virtual reality development documentation, smart city infrastructure plans, precision agriculture techniques, financial technology compliance frameworks, blockchain transaction records, autonomous vehicle testing protocols, quantum computing research abstracts, satellite imagery analysis, urban planning zoning documents, cybersecurity vulnerability assessments, telehealth service protocols, biometric data policies, nanotechnology fabrication processes, esports tournament regulations, fashion industry trend reports, music industry royalties agreements, cryptocurrency regulatory advisories, 3D printing design file descriptions and information, water resource management studies, soil fertility research papers, wildlife conservation strategies, public transportation efficiency studies, energy grid reliability analyses, cloud data encryption standards, augmented reality user experiences, social network data analytics, video game development milestones, film production schedules, literary copyright registrations, microgrid deployment blueprints, oceanography expedition logs, virtual event platform specifications, agricultural drone operation manuals, smart home integration guides, space exploration mission briefings, podcast production outlines, digital literacy curriculum frameworks, electric vehicle charging network plans, mental health intervention strategies, urban agriculture initiatives, renewable resource mapping, corporate ethics investigation reports, gig economy worker rights policies, climate change adaptation measures, mobile banking security protocols, digital identity verification methods, language translation algorithms, sports analytics models, fashion e-commerce return policies, educational technology adoption strategies, disaster recovery documentation, influencer marketing contracts, data center efficiency audits, voice assistant command libraries, gene editing ethical guidelines, smartwatch health monitoring feature manuals, international cybersecurity alliance documents, digital art preservation techniques, etc.

Chatbot applications and their supporting LLMs (or other AI systems) may search existing contexts to identify areas that are unrelated to the main message or objective of each section. The user may want to clean up or delete the content of these unrelated areas, particularly when the phrase, sentence, paragraph, etc., was created by users that may be working counter to the aim of the individual or team. The system may ask the user whether to delete or archive the identified content from the topic region or the chatbot region of the user interface 200.

In certain embodiments, the change and or redline could be implemented such that input from a human and input from an artificial intelligence could be identified and tracked over time.

In a similar use case, collaborative editing of two or more of one or more of either a human and human or artificial intelligence and or human and or artificial intelligence and or other artificial intelligence. Existing LLMs are good at text completion but in collaborative editing the system needs to only know what changes are made and at what position those changes were made or suggested. This would allow the system and interface to be able to track and identify adjustments made and by which of different kinds of users, including artificial intelligence users and or human users, were the ones making the changes. Multiple simultaneous users would be able to simultaneously edit the document. This simultaneous editing and tracking feature could be done by one or more methods including CRDT. For example, The CRDT algorithm, or Conflict-Free Replicated Data Type, is a family of data structures and algorithms that allows for distributed systems to achieve strong eventual consistency without needing to synchronize through a central server or resolve conflicts through complex algorithms. CRDTs are particularly useful in scenarios where network partitions can temporarily isolate nodes, or when the system must continue to operate in a decentralized manner with high availability, such as in collaborative applications (e.g., collaborative text editing, distributed databases).

CRDTs can be classified into two main categories based on their approach to integrating concurrent updates: 1) State-based CRDTs (CvRDTs): Each node in the system maintains a state that is periodically synchronized with other nodes. The states are merged using a mathematical operation that ensures idempotence (if an operation is repeated once or more than once, the same result is achieved), commutativity, and associativity, which means that the order of merge operations does not affect the final state. This property guarantees convergence to the same state across all nodes, assuming all updates are eventually delivered. 2) Operation-based CRDTs (CmRDTs): Instead of sharing and merging states, nodes transmit operations that need to be applied to other nodes' states. These operations are designed to be commutative, meaning they can be applied in any order and still produce the same final state. For this to work reliably, the system must ensure that all operations are delivered at least once and often requires a reliable broadcast mechanism to prevent operations from being lost. Additionally, with CRDT you can just have the edits show up as annotations that one or more users could approve for addition or modification to the document, such as the modification 278 that is displayed as underlined text in FIG. 7 (“This suggests that the patient is still in pain. I wonder if this patient is a criminal.”).

The many features and advantages of the disclosure are apparent from the detailed specification, and, thus, it is intended by the appended claims to cover all such features and advantages of the disclosure which fall within the scope of the disclosure. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

What is claimed is:

1. A computer, comprising:
a memory configured to store a plurality of phase modules for a strategic innovation process, wherein:
each phase module is configured to present one or more user interfaces (UIs) to a user,
each UI includes a topic region and a chatbot region that is associated with a chatbot application that is coupled to a large language model (LLM),
the topic region is configured to present information created by the user and information created by the LLM, and
the chatbot region is configured to receive natural language text from the user, and present information generated by the LLM; and
a processor coupled to the memory and a network, the processor configured to:
for each phase module, send, to a client computer over the network, the UI for presentation to the user,
receive, from the client computer over the network, natural language text,
generate, by the LLM, information for the topic region based at least in part on the natural language text, and
send the information for the topic region to the client computer for presentation to the user.

2. The computer of claim 1, wherein the processor is further configured to:
generate a document based on the information for the topic region; and
send the document to the client computer over the network.

3. The computer of claim 1, wherein the chatbot application is coupled to the LLM over the network.

4. The computer of claim 1, wherein the information generated by the LLM includes a header, one or more subheaders, and one or more sections, and each subheader is followed by a section that includes information associated with the subheader.

5. The computer of claim 4, wherein the topic region is configured to accept changes to the information.

6. The computer of claim 5, wherein the changes to the information are created by the LLM.

7. The computer of claim 6, wherein the changes to the information are created by the user.

8. The computer of claim 7, wherein the changes to the information are created by the user by inputting text into the chatbot region or the topic region.

9. The computer of claim 4, wherein:
the topic region is configured to accept changes to the information that are created by a plurality of users and one or more LLMs;
the topic region is configured to display each change to the information with an indication of a source of the change; and
the source of the change is one of the users or one of the LLMs.

10. The computer of claim 9, wherein the processor is further configured to track the changes to the information by each source over time.

11. The computer of claim 10, wherein the processor is further configured to track the changes to the information by each source over time.

12. The computer of claim 11, wherein:
the topic region includes a lock widget; and
the processor is further configured to:
in response to a selection of the lock widget by one of the users, prevent changes to the information by the other sources.

13. The computer of claim 12, wherein the processor is further configured to:
in response to a selection of the lock widget by one of the users, prevent changes to the information by all of the sources.

14. The computer of claim 11, wherein the processor is further configured to store the information for each topic area in memory using Conflict-Free Replicated Data Types (CRDTs).

15. The computer of claim 1, wherein the phase modules include two or more phase modules selected from an alignment phase module, a research and observations phase module, a solution agnostic phase module, a solution generation phase module, and a solution implementation phase module.

16. The computer of claim 15, wherein the alignment phase module is configured to:
determine target criteria, determine categories, generate rubrics, and evaluate inputs against the target criteria using the rubrics.

17. The computer of claim 15, wherein the research and observations phase module is configured to:
research information, generate templates, generate insights, and output opportunity areas.

18. The computer of claim 15, wherein the solution agnostic phase module is configured to:
identify best unmet needs of stakeholders, identify outcomes defining objectives of stakeholders, generates statements under guidance of one or more LLMS and user input, and revises the statements based on additional user input.

19. The computer of claim 15, wherein the solution generation phase module is configured to:
generate a description of solutions, classify solutions into one or more solution groups, rank solutions against criteria, evaluate solutions against one another, determine a degree of fitness of each solution, determine a landscape of fitness, and select a solution for implementation.

20. The computer of claim 15, wherein the solution implementation phase module is configured to:
refine an opportunity area and a solution through LLM interactions, explore intellectual property, regulatory, and legal regimes through LLM interactions, generate a market plan based on the solution, and optimize the market plan through LLM interactions.
